(19) United States
(12) Patent Application Publication
(10) Pub. No.: US 2023/0164608 A1
(43) Pub. Date: May 25, 2023

(54) ELECTRONIC DEVICE AND METHOD FOR WIRELESS COMMUNICATION AND COMPUTER-READABLE STORAGE MEDIUM

(71) Applicant: Sony Group Corporation, Tokyo (JP)

(72) Inventors: Fuliang LIU, Beijing (CN); Zhaocheng WANG, Beijing (CN); Jianfei CAO, Beijing (CN)

(73) Assignee: Sony Group Corporation, Tokyo (JP)

(21) Appl. No.: 17/912,524

(22) PCT Filed: Mar. 22, 2021
(86) PCT No.: PCT/CN2021/082017

§ 371 Date: Sep. 19, 2022

(30) Foreign Application Priority Data
Mar. 27, 2020 (CN) 202010229181.0

(51) Int. Cl. H04W 24/10; H04W 76/23

(52) U.S. Cl. CPC H04W 24/10; H04W 76/23

(57) ABSTRACT

An electronic device comprises a processing circuit, the processing circuit being configured to: generate interference measurement configuration information, which indicates the configuration of a reference signal to be transmitted by a device under measurement that multiplexes wireless communication resources with a D2D receiver within a cell in which the D2D receiver is located; transmit the interference measurement configuration information to the D2D receiver; and receive an interference measurement report from the D2D receiver, the interference measurement report being obtained by measuring, according to the interference measurement configuration information, the receiving signal of the reference signal transmitted by the device under measurement at the D2D receiver, as interference to the D2D receiver. Hence, interference to a D2D receiver can be measured when a D2D device multiplexes cellular network resources, thus making it possible to reduce said interference by means of scheduling or power control.

The present application claims priority to Chinese Patent Application No. 202010229181.0, titled “ELECTRONIC DEVICE AND METHOD FOR WIRELESS COMMUNICATION AND COMPUTER-READABLE STORAGE MEDIUM”, filed on Mar. 27, 2020 with the Chinese Patent Office, which is incorporated herein by reference in its entirety.

### FIELD

The present disclosure relates to the technical field of wireless communication, and in particular to an electronic device and method for wireless communication capable of measuring interference to a D2D receiver in a scenario where a D2D device multiplexes wireless communication resources, and a non-transient computer-readable storage medium.

### BACKGROUND

Device to device (D2D) communication is regarded as one of key technologies of a 5G wireless communication system due to huge application prospect and potential performance gain. Resource multiplexing between a D2D link and a cellular user link can improve a spectral efficiency of a system. In related technologies, a method for a D2D device multiplexing cellular network resources is that the D2D device multiplexes the same transmission resources with the cellular user equipment to improve resource utilization. However, such multiplexing may introduce interference between links, which may affect system performance. Therefore, it is desired to effectively measure the interference between links.

### SUMMARY

In the following, an overview of the present disclosure is given simply to provide basic understanding to some aspects of the present disclosure. It should be understood that this overview is not an exhaustive overview of the present disclosure. It is not intended to determine a critical part or an important part of the present disclosure, nor to limit the scope of the present disclosure. An object of the overview is only to give some concepts in a simplified manner, which serves as a preface of a more detailed description described later.

In view of the above problems, an electronic device and method for wireless communication and a non-transient computer-readable storage medium are provided according to at least one aspect of the present disclosure, to measure interference to a D2D receiver in a scenario where a D2D device multiplexes cellular network resources.

According to an aspect of the present disclosure, an electronic device is provided. The electronic device includes processing circuitry. The processing circuitry is configured to: generate interference measurement configuration information indicating a configuration of a reference signal to be transmitted by a device under measurement, with which a D2D receiver multiplexes wireless communication resources, in a cell where the D2D receiver is located; transmit the interference measurement configuration information to the D2D receiver, and receive an interference measurement report from the D2D receiver, the interference measurement report being obtained by measuring, as interference to the D2D receiver, a reception signal at the D2D receiver of the reference signal transmitted by the device under measurement according to the interference measurement configuration information.

According to another aspect of the present disclosure, an electronic device is further provided. The electronic device includes processing circuitry. The processing circuitry is configured to: receive, from a base station, interference measurement configuration information indicating a configuration of a reference signal to be transmitted by a device under measurement, with which a D2D receiver multiplexes wireless communication resources, in a cell where the D2D receiver is located; measure, according to the received interference measurement configuration information, a reception signal at the D2D receiver of the reference signal transmitted by the device under measurement as interference to the D2D receiver to obtain an interference measurement report; and transmit the interference measurement report to the base station.

According to another aspect of the present disclosure, a method for wireless communication is further provided. The method includes: generating interference measurement configuration information indicating a configuration of a reference signal to be transmitted by a device under measurement, with which a D2D receiver multiplexes wireless communication resources, in a cell where the D2D receiver is located; transmitting the interference measurement configuration information to the D2D receiver; and receiving an interference measurement report from the D2D receiver, the interference measurement report being obtained by measuring, as interference to the D2D receiver, a reception signal at the D2D receiver of the reference signal transmitted by the device under measurement according to the interference measurement configuration information.

According to another aspect of the present disclosure, a method for wireless communication is further provided. The method includes: receiving, from a base station, interference measurement configuration information indicating a configuration of a reference signal to be transmitted by a device under measurement, with which a D2D receiver multiplexes wireless communication resources, in a cell where the D2D receiver is located; measuring, according to the received interference measurement configuration information, a reception signal at the D2D receiver of the reference signal transmitted by the device under measurement as interference to the D2D receiver to obtain an interference measurement report; and transmitting the interference measurement report to the base station.

According to another aspect of the present disclosure, a non-transient computer-readable storage medium storing executable instructions is further provided. The executable instructions, when executed by a processor, causes the processor to perform various functions of the above method or electronic device for wireless communication.

According to other aspects of the present disclosure, computer program codes and computer program products for implementing the above method according to the present disclosure are further provided.

According to at least one aspect of the embodiments of the present disclosure, for a case where a D2D device multiplexes cellular network resources, interference to a D2D receiver can be measured, thereby providing possibility of reducing the interference to the D2D receiver through scheduling or power control.

Other aspects of the embodiments of the present disclosure are given in the following description. Preferred embodiments for fully disclosing the embodiments of the present disclosure are described in detail without limitation.

### BRIEF DESCRIPTION OF THE DRAWINGS

The drawings described herein are only for illustrating some of the embodiments rather than all the embodiments, and are not intended to limit the scope of the present disclosure. In the drawings:

FIG. 1 is a schematic diagram showing interference in an exemplary scenario of multiplexing uplink communication resources in D2D communication;

FIG. 2 is a block diagram showing a first configuration example of an electronic device at a base station side according to an embodiment of the present disclosure;

FIG. 3 is a block diagram showing a second configuration example of the electronic device at a base station side according to an embodiment of the present disclosure;

FIG. 4 is a schematic diagram showing an example of a reference signal pre-configured by a configuration unit in the electronic device shown in FIG. 3 for a device under measurement;

FIG. 5 is a block diagram showing a third configuration example of the electronic device at a base station side according to an embodiment of the present disclosure;

FIG. 6 is a schematic diagram showing interference in an exemplary scenario to which the electronic device shown in FIG. 5 is applicable;

FIG. 7 is a schematic diagram showing an example in which a determination unit in the electronic device shown in FIG. 5 determines an expected high-interference device under measurement;

FIG. 8 is a schematic diagram showing signaling overhead of interference measurement configuration generated by a generation unit in the electronic device shown in FIG. 5;

FIG. 9 is a block diagram showing a fourth configuration example of the electronic device at a base station side according to an embodiment of the present disclosure;

FIG. 10 is block diagram showing a configuration example of an electronic device at a D2D receiver side according to an embodiment of the present disclosure;

FIG. 11 is a flowchart showing a first example of an information interaction process according to an embodiment of the present disclosure;

FIG. 12 is a flowchart showing a second example of the information interaction process according to an embodiment of the present disclosure;

FIG. 13 is a flowchart showing a third example of the information interaction process according to an embodiment of the present disclosure;

FIG. 14 is a flowchart showing a fourth example of the information interaction process according to an embodiment of the present disclosure;

FIG. 15 is a flowchart showing a fifth example of the information interaction process according to an embodiment of the present disclosure;

FIG. 16 is a flowchart showing a process example of a method for wireless communication at a based station side according to an embodiment of the present disclosure;

FIG. 17 is a flowchart showing a process example of a method for wireless communication at a D2D receiver side according to an embodiment of the present disclosure;

FIG. 18 is a block diagram showing a first example of an exemplary configuration of an eNB to which the technology according to the present disclosure may be applied;

FIG. 19 is a block diagram showing a second example of an exemplary configuration of the eNB to which the technology according to the present disclosure may be applied;

FIG. 20 is a block diagram showing an example of an exemplary configuration of a smartphone to which the technology according to the present disclosure may be applied; and

FIG. 21 is a block diagram showing an example of an exemplary configuration of a car navigation device to which the technology according to the present disclosure may be applied.

Although the present disclosure is susceptible to various modifications and substitutions, specific embodiments thereof are shown in the drawings as examples and are described in detail herein. However, it should be understood that the description of specific embodiments herein is not intended to limit the present disclosure into a disclosed specific form. Instead, the present disclosure aims to cover all modifications, equivalents and substitutions within the spirit and the scope of the present disclosure. It should be noted that, corresponding reference numerals indicate corresponding components throughout the drawings.

### DETAILED DESCRIPTION OF EMBODIMENTS

Now, examples of the present disclosure are described more fully with reference to the drawings. The following description is merely illustrative in nature and is not intended to limit the present disclosure and application or use.

Exemplary embodiments are provided so that the present disclosure becomes exhaustive and the scope of the present disclosure is fully conveyed to those skilled in the art. Examples of various specific details such as specific components, apparatuses, and methods are set forth to provide detailed understanding of the embodiments of the present disclosure. It is apparent to those skilled in the art that without specific details, the exemplary embodiments may be implemented in multiple different forms, none of which is construed as limiting the scope of the present disclosure. In some exemplary embodiments, well-known processes, well-known structures, and well-known technologies are not described in detail.

The present disclosure is described in the following order:

1. Description of Problem

2. Configuration Example of Electronic Device at Base Station Side

3. Configuration Example of Electronic Device at D2D Receiver Side

4. Example of Information Interaction Process

5. Method Embodiment

6. Application Example

### 1. Description of Problem

Multiplexing cellular network resources in D2D communication can improve the utilization efficiency of the resources. In particular, multiplexing the same wireless communication resources by a D2D device and cellular user equipment is an effective way to further improve resource utilization. However, this multiplexing may introduce interference between links, which may affect the system performance.

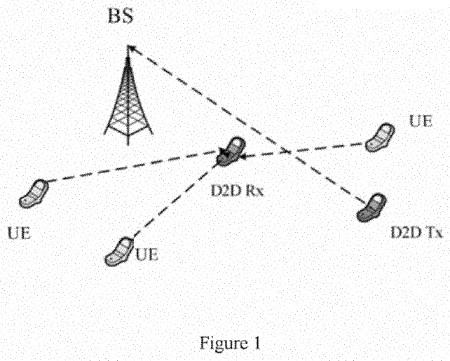

Specifically, on the one hand, in a case of multiplexing downlink communication resources in D2D communication, a D2D transmitter causes interference to downlink cellular user equipment, and a D2D receiver is interfered by downlink transmission of a base station. On the other hand, in a case of multiplexing uplink communication resources in D2D communication, D2D transmitter interferes with uplink transmission of a cellular user at the base station, and D2D receiver is interfered by an uplink cellular user. As an example, refer to FIG. 1, which shows interference in a case of multiplexing uplink communication resources in D2D communication. The interference is indicated by a dotted line with an arrow.

Therefore, in order to reduce the interference to the D2D receiver through various means such as scheduling or power control, it is desired to measure the interference to the D2D receiver when the D2D device multiplexes wireless communication resources.

An electronic device at the base station side, an electronic device at the D2D receiver side, a method for wireless communication, and a computer-readable storage medium are provided according to the present disclosure for such a scenario, so that the electronic device at the D2D receiver side measures the interference to the D2D receiver according to interference measurement configuration information from the electronic device at the base station side, thereby providing the possibility of reducing the interference to the D2D receiver through scheduling or power control.

The electronic device at the base station side according to the present disclosure may be the base station device, for example, an eNB (evolved node B) or a gNB. In addition, the electronic device at the base station side according to the present disclosure may further include an electronic device at a network side other than the base station device. Theoretically, the electronic device at the base station side may be any type of TRP (Transmit and Receive Port). The TRP may have a function of transmitting and receiving. For example, the TRP may receive information from user equipment and a base station device, or transmitting information to the user equipment and the base station device. In an example, the TRP may serve the user equipment and controlled by the base station device. That is, the base station device serves the user equipment through the TRP. In some embodiments or examples below, an example in which the base station device directly serves as the electronic device at the base station side is described. However, the present disclosure is not limited to the example, and may be appropriately applied to the case of the electronic device at the network side.

The electronic device at the D2D receiver side according to the present disclosure may be various user equipment operating in a D2D mode, for example, a mobile terminal (such as a smart phone, a tablet personal computer (PC), a notebook PC, a portable game terminal, a portable/dongle type mobile router and digital imaging apparatus) or a vehicle terminal (such as a car navigation device). The above user equipment may also be implemented as a terminal that performs machine to machine (M2M) communication (also referred to as a machine type communication (MTC) terminal). In addition, the user equipment may be a wireless communication module (such as an integrated circuit module including a single chip) installed on each of the above terminals.

### 2. Configuration Example of Electronic Device at Base Station Side

[First Configuration Example of Electronic Device at Base Station Side]

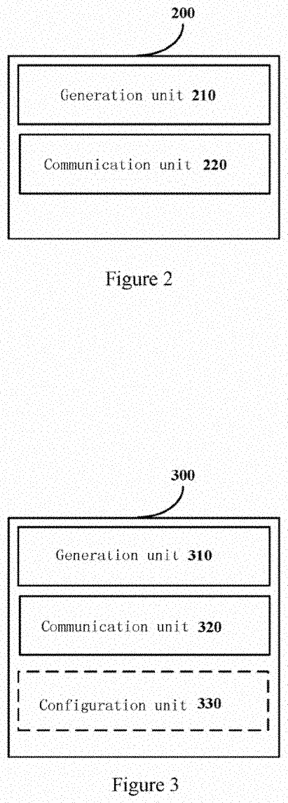

FIG. 2 is a block diagram showing a first configuration example of an electronic device at a base station side according to an embodiment of the present disclosure.

As shown in FIG. 2, the electronic device 200 may include a generation unit 210 and a communication unit 220.

Here, units of the electronic device 200 may be included in a processing circuit. It should be noted that the electronic device 200 may include one processing circuitry or multiple processing circuitry. Further, the processing circuitry may include various separate functional units to perform various functions and/or operations. It should be noted that these functional units may be physical entities or logical entities, and units with different names may be implemented by one physical entity.

According to the embodiments of the present disclosure, the generation unit 210 may interference measurement configuration information to be transmitted to the D2D receiver. The interference measurement configuration information indicates a configuration of a reference signal to be transmitted by a device under measurement, with which the D2D receiver multiplexes wireless communication resources, in a cell where the D2D receiver is located. Here, the cell where the D2D receiver is located may be a service coverage of the base station corresponding to the electronic device 200. For example, the D2D receiver may be geographically within the coverage of the base station, or very close to the base station. In a case that the electronic device 200 itself is the base station device, “base station corresponding to the electronic device 200” refers to the base station device of the electronic device 200 itself. In addition, in a case that the electronic device 200 communicates with the base station device and some functions of the base station device are implemented, “base station corresponding to the electronic device 200” refers to the base station device.

Further, there may be multiple pairs of D2D transmitters and D2D receivers for D2D communication in the cell where the D2D receiver is located. Therefore, for example, the generation unit 210 successively transmits interference measurement configuration information for multiple D2D receivers in a certain time order, so that the D2D receivers successively measure interference according to the received interference measurement configuration information. The processing for one of the D2D receivers is described here and below. It can be understood by those skilled in the art that all processing for the multiple D2D receivers can be realized by repeating such processing.

According to the embodiments of the present disclosure, the communication unit 200 may transmit the interference measurement configuration information generated by the generation unit 210 to the D2D receiver, and receive an interference measurement report from the D2D receiver. The interference measurement report is obtained by measuring, as interference to the D2D receiver, a reception signal at the D2D receiver of the reference signal transmitted by the device under measurement according to the interference measurement configuration information. That is, the D2D receiver, according to the interference measurement configuration information, measures the reception signal at the D2D receiver of the reference signal transmitted by the device under measurement as the interference to the D2D receiver, so as to obtain the interference measurement report and transmit the report to the electronic device 200.

It can be seen that the electronic device 200 at the base station side according to the embodiments of the present disclosure is capable of providing interference measurement configuration information for the electronic device at the D2D receiver side, so that the electronic device at the D2D receiver side measures the interference to the D2D receiver according to the interference measurement configuration information, thereby providing the possibility of reducing the interference to the D2D receiver through scheduling or power control.

Preferably, the wireless communication resources multiplexed by the D2D receiver with the device under measurement include uplink communication resources. The advantages of preferably multiplexing the uplink communication resources include that the utilization rate of the uplink communication resources is lower than that of downlink communication resources, and the multiplexing of the uplink communication resources by the D2D device does not cause interference to an existing downlink cellular user. In addition, the interference of this multiplexing to the base station can be measured and eliminated by the base station itself.

In a case of multiplexing the uplink communication resources in D2D communication, the device under measurement (i.e., device that may cause interference to the D2D receiver), with which a D2D receiver multiplexes wireless communication resources, in the cell where the D2D receiver is located may include uplink cellular user equipment. In addition, in a case that there are more than one pair of D2D devices in the cell where the D2D receiver is located, the device under measurement, with which the D2D receiver multiplexes wireless communication resources, in the cell where the D2D receiver is located may further include a D2D transmitter (hereinafter, it can also be simply referred to as “other D2D transmitters”) other than the D2D transmitter corresponding to the subject D2D receiver. Hereinafter, in a case that it is unnecessary to distinguish the cellular user equipment in the devices under measurement from other D2D transmitter in the devices under measurement, the cellular user equipment and the D2D transmitter are collectively referred to as device under measurement.

The electronic device 200 according to the embodiments of the present disclosure may be applied to a scenario where beamforming is used on both a network side (for example, a base station) such as a millimeter wave cellular network and user equipment side (for example, cellular user equipment and a D2D device). Therefore, optionally, in the embodiments of the present disclosure, the D2D receiver and the device under measurement respectively use specific beams (i.e., directional beams rather than omnidirectional beams) for communication.

[2.2 Second Configuration Example of Electronic Device at Base Station Side]

FIG. 3 is a block diagram showing a second configuration example of the electronic device at a base station side according to an embodiment of the present disclosure. The third configuration example shown in FIG. 3 is an example further improved based on the first configuration example shown in FIG. 2. Therefore, the following description is made based on the first configuration example shown in FIG. 2.

As shown in FIG. 3, the electronic device 300 may include a generation unit 310 and a communication unit 320, which are respectively similar to the generation unit 210 and the communication unit 220 in the electronic device 200 shown in FIG. 2. In addition, the electronic device 300 further includes a configuration unit 310 configured to pre-configure, for each device under measurement in the cell, a reference signal to be transmitted by the device under measurement.

As an example, in a case that the device under measurement is the cellular user equipment in the cell where the D2D receiver is located, the reference signal pre-configured by the configuration unit 310 for the device under measurement may be an uplink reference signal used in the communication between the cellular user equipment and the base station. In other words, the reference signal to be transmitted by the cellular user equipment for the D2D receiver to measure the interference is not specially configured by the electronic device 300 at the base station side for the interference measurement of the D2D receiver, but the pre-configured uplink reference signal used in the communication between the cellular user equipment serving as the device under measurement and the base station.

As another example, in a case that the device under measurement is other D2D transmitter in the cell where the D2D receiver is located, the reference signal configured by the configuration unit 310 for the device under measurement may be a reference signal of the same type as the reference signal pre-configured for the cellular user equipment.

Preferably, the configuration unit 310 may pre-configure reference signals of at least some or even all devices under measurement in the cell to occupy continuous or concentrated time and frequency resources. In the present disclosure, occupying “continuous or concentrated” time resources/frequency resources, for example, indicates that the occupied time resources/frequency resources are continuous or concentrated in a certain time range/frequency range. In a case that the reference signals configured in this way are used, the signaling overhead for interference measurement configuration information can be reduced in an appropriate scenario. For example, as a simplified processing, if it is only desired to consider overall interference of each device under measurement to the D2D receiver, in a case of pre-configuring multiple reference signals occupying continuous or concentrated time and frequency resources for these devices under measurement, the interference measurement configuration information generated by the generation unit 310 of the electronic device 300 only indicates a union of time and frequency resources of the reference signals of all devices under measurement, and the communication unit 320 transmits such interference measurement configuration information for the D2D receiver to measuring the above overall interference.

As an example, the reference signal occupying continuous or concentrated time and frequency resources pre-configured by the configuration unit 310 for each device under measurement in the cell may include a sounding reference signal (SRS). The sounding reference signal is in a form of a ZC (Zadoff-Chu) sequence with a constant modulus feature and a good autocorrelation feature. The definition of such ZC sequence depends on a sequence length (usually a prime number), a root index and a cyclic shift. Two ZC sequences with different cyclic shifts are quasi orthogonal, so that two users configured with ZC sequences having different cyclic shifts can be distinguished at the receiver.

For an SRS reference signal that may be used for interference measurement, for example, an SRS reference signal in a form of ZC sequence, configuration of the SRS reference signal mainly includes three aspects: time resources, frequency resources and a sequence. According to specification of 3GPP TS 38.211, the configuration of time resources may include a serial number of a time slot occupied by the SRS and a serial number of an OFDM symbol occupied by the SRS. Periodic or aperiodic SRS may start with OFDM symbols numbered 8 to 13 and last for 1 symbol, 2 consecutive symbols or 4 consecutive symbols. The configuration of frequency resources includes a starting position of a frequency domain, a comb number and a comb offset that determine a subcarrier interval, and the number of resource blocks occupied by the frequency domain. The configuration of the sequence includes a root index and a cyclic shift of the ZC sequence. A short sequence supports 30 root indexes. A long sequence supports 60 root indexes, and supports 8 or 12 cyclic shifts according to different comb numbers.

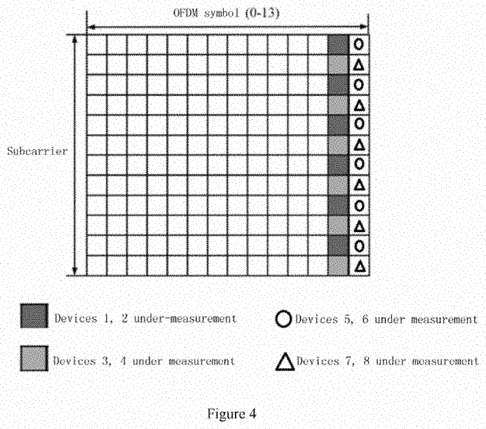

FIG. 4 is a schematic diagram showing an example of a reference signal pre-configured by the configuration unit 310 in the electronic device 300 shown in FIG. 3 for the device under measurement. FIG. 4 shows an example of the SRS reference signal in the above form pre-configured by the configuration unit 330 for multiple devices 1 to 8 under measurement in the cell. More specifically, time and frequency resources in a resource block occupied by the SRS reference signals of the devices 1 to 8 under measurement are shown. In this example, the devices 1 under measurement and the device 2 under measurement are regarded as a group, so that the SRS reference signals of the two devices under measurement occupy the same time and frequency resources. The occupied time domain starts with an OFDM symbol numbered 12. The number of continuous OFDM symbols is 1. The occupied frequency domain starts with a sub carrier wave with numbered 0. The comb number is equal to 2 and the comb offset is 0. It should be noted that the configuration unit 310 configures the root index and the cyclic shift of the ZC sequence of the SRS reference signals of the device 1 under measurement to be different from these of the device 2 under measurement, so that the SRS reference signals of the two devices have different sequence configurations. Therefore, the two devices can be distinguished at the receiver. Similarly, the device 3 under measurement and the device 4 under measurement form a group. The device 5 under measurement and the device 6 under measurement form a group. The device 7 under measurement and the device 8 under measurement form a group. The configuration unit 310 configures the SRS reference signals of the two devices under measurement in each group to occupy the same time and frequency resources and use different ZC sequences.

As shown in FIG. 4, the SRS reference signals of the devices 1 to 8 under measurement continuously or concentratedly occupy time and frequency resources with a time domain having a starting position of 12, the number of continuous OFDM symbols of 2, a frequency domain having a starting position of 0 and the number of resource blocks of 1. These time and frequency resources are a union of the time and frequency resources occupied by the reference signals of the devices 1 to 8 under measurement. In such a configuration, the interference measurement configuration information generated by the generation unit 310 of the electronic device 300 and transmitted by the communication unit 320 may only indicate the above union occupied by the time and frequency resources of the reference signals of the devices 1 to 8 under measurement, for the D2D receiver to measure the overall interference of the devices 1 to 8 under measurement. As an example, the devices 1 to 8 under measurement may be all cellular user equipment. Alternatively, some of the devices 1 to 8 under measurement are cellular user equipment, and some of the devices 1 to 8 under measurement are other D2D transmitters, which depends on a scenario to which the electronic device 300 according to the embodiments of the present disclosure is applied, and is not repeated here.

Referring to FIG. 4 and taking the SRS reference signal as an example, an ideal situation in which the reference signal of each device under measurement in the cell is pre-configured to occupy continuous or concentrated time and frequency resources is described. Preferably, the above configuration is performed on all devices under measurement in the cell. However, in practical application, the configuration unit 310 may only pre-configure reference signals occupying continuous or concentrated time and frequency resources for a part of the devices under measurement (for example, all cellular user equipment or some of the cellular user equipment) in the cell, while pre-configure reference signals occupying other time and frequency resources for other devices under measurement (for example, D2D transmitters that may cause interference) in the cell. It should be understood that this possibility can still reduce the signaling overhead for the interference measurement configuration information to a certain extent in appropriate scenarios. In addition, the configuration unit 310 may also configure a reference signal other than the SRS reference signal for the device under measurement, which will be described in detail in the following embodiments.

The second configuration example of the electronic device at the base station side according to the embodiments of the present disclosure is described above. As described above, in the second configuration example, the configuration unit of the electronic device configuring the reference signal to be transmitted by the device under measurement to occupy continuous or concentrated time and frequency resources to cause the generate unit to generate interference measurement configuration information indicating only the union of the time and frequency resources in appropriate scenarios, so as to reduce the signaling overhead of the communication unit transmitting such interference measurement configuration information.

[2.3 Third Configuration Example of Electronic Device at Base Station Side]

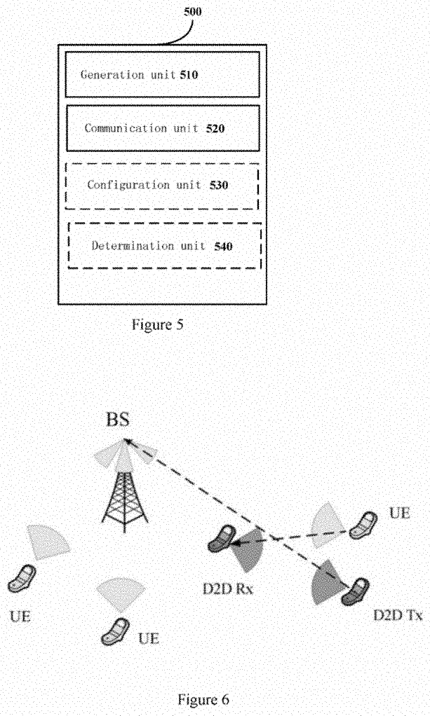

FIG. 5 is a block diagram showing a third configuration example of an electronic device at a base station side. The third configuration example shown in FIG. 5 is an example further improved based on the second configuration example shown in FIG. 3. Therefore, the following description is made based on the second configuration example shown in FIG. 3.

As shown in FIG. 5, the electronic device 500 may include a generation unit 510, a communication unit 520, and a configuration unit 530, which are similar to units 310 to 330 of the electronic device 300 shown in FIG. 3, respectively. In addition, the electronic device 500 further includes a determination unit 540 configured to determine an expected high-interference device under measurement based on position information of the D2D receiver and position information of the device under measurement in the cell.

The electronic device 500 in this embodiment is particularly applicable to the following scenario in which the D2D receiver within the service coverage of the electronic device suffers great interference from a part of the devices under measurement and suffers small interference from other part of the devices under measurement due to factors such as relative positions. Accordingly, the generation unit 510 of the electronic device 500 may generate interference measurement configuration information with an appropriate level of detail as will be further described later according to the expected high-interference device determined in this way, thereby reducing the signaling overhead of the communication unit 520 transmitting the information.

Examples of such scenario to which the electronic device 500 according to this embodiment is applicable include cases where these devices operate in a millimeter wave cellular network. Interference in the millimeter wave cellular network is very different from that in an LTE network. In the LTE network, the use of an omnidirectional antenna by the user equipment results in random interference, that is, there may be interference between any two links. In the millimeter wave cellular network, due to a high link loss of a millimeter wave band, the user equipment usually uses multiple antennas to form a specific directional beam to improve signal receiving power. Therefore, the interference is sparse and exists only between a few of links.

FIG. 6 is a schematic diagram showing interference in an exemplary scenario to which the electronic device shown in FIG. 5 is applicable. FIG. 6 shows an example of sparse interference in a millimeter wave cellular network. Beams at various devices such as the base station BS, the device under measurement UE, the D2D transmitter D2D TX and the D2D receiver D2D RX are indicated by sectors, and interference is indicated by dotted lines with an arrow. As shown in FIG. 6, the D2D receiver D2D RX only receives interference from one device under measurement, that is, the UE shown on the right of the Figure (i.e., only interfered by the UE shown on the right of the Figure). Therefore, in a case the electronic device according to this embodiment is applied to such a scenario, for devices under measurement other than the high-interference device under measurement involving such a few links, the D2D receiver may measure interference for each device under measurement without interference measurement configuration information of the device under measurement. It should be noted that although some contents of this preferred embodiment and subsequent embodiments are described below in connection with the millimeter wave cellular network, those skilled in the art can understand that the contents of the relevant embodiments are similarly applicable to cases where other wireless communication resources are multiplexed when appropriate.

As an example, the position information of the D2D receiver and the position information of the device under measurement based on which the determination unit 540 determines the expected high-interference device under measurement may respectively indicate a position of the D2D receiver and a position of the device under measurement, so that the determination unit 540 may determine a distance between the D2D receiver and the device under measurement according to the position information of the D2D receiver and the position information of the device under measurement. Accordingly, the determination unit 540, for example, may determine the device under measurement as the expected high-interference device under measurement, in a case that the distance between the D2D receiver and the device under measurement is less than a predetermined threshold Dₜₕ. Hereinafter, the above distance based determination standard is also referred to as a distance based first standard.

As another example, in addition to the position information of the D2D receiver and the position information of the device under measurement, additional information may further be obtained to determine the expected high-interference device under measurement in other ways.

For example, in cases such as the above case of the millimeter wave cellular network, that is, in a case where the D2D receiver and the device under measurement respectively use specific beams (directional beams rather than omnidirectional beams) for communication, the determination unit 540 may determine the device under measurement as the expected high-interference device under measurement in a case that a transmission beam of the device under measurement covers the position of the D2D receiver and/or a reception beam of the D2D receiver covers the position of the device under measurement. Hereinafter, the above standard of “a transmission beam of the device under measurement covers the position of the D2D receiver” for determining the expected high-interference device under measurement is referred to as a beam-coverage-based second standard, and the standard of “a reception beam of the D2D receiver covers the position of the device under measurement” for determining the expected high-interference device under measurement is referred to as a beam-coverage-based third standard.

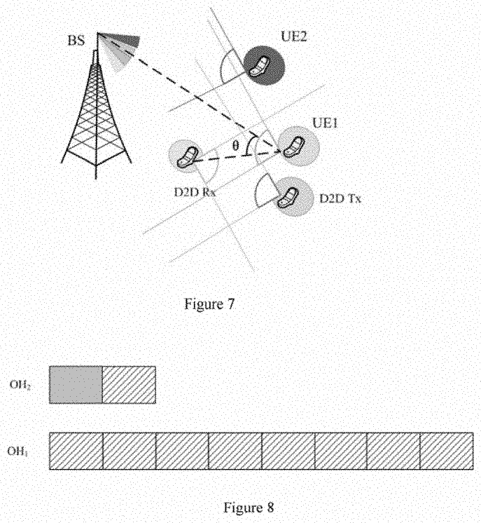

Next, specific determination examples of the above first standard to third standard are described with reference to FIG. 7. FIG. 7 is a schematic diagram showing an example in which the determination unit in the electronic device shown in FIG. 5 determines the expected high-interference device under measurement. In FIG. 7 shows, in a case where the D2D receiver and the device under measurement respectively use specific beams for communication, an exemplary scenario in which the determination unit 540 determines the expected high-interference device under measurement based on the above first standard to third standard. More specifically, in the example shown in FIG. 7, a pair of D2D devices within the coverage of the base station BS is shown, which includes the D2D transmitter D2D Tx and the D2D receiver D2D Rx. For simplicity, only two cellular user equipment UE1 and UE2 as examples of the devices under measurement are shown exemplarily. It should be noted that although two cellular user equipment UE1 and UE2 are taken as examples of the devices under measurement here, this example is appropriately applicable to a case where the device under measurement includes more cellular user equipment and/or other D2D transmitters.

The determination unit 540 may perform determination based on the distance based first standard for the exemplary scenario shown in FIG. 7. For example, the determination unit 540 may first determine a distance between UE1 and D2D Rx and a distance between UE2 and D2D Rx, and determine whether the distance is less than the predetermined distance threshold Dₜₕ. In this example, the distance between UE1 and D2D Rx is less than the distance threshold Dₜₕ, and the distance between UE2 and D2D Rx is greater than or equal to the distance threshold Dₜₕ. Therefore, the determination unit 540 determines that UE1 meets the first standard and UE2 does not meet the first standard.

The determination unit 540 may further perform determination based on the beam-coverage-based second standard, that is, determine whether the transmission beams of the cellular user equipment UE1 and UE2 cover the position of D2D Rx. As an example of the second standard, the determination unit 540 may calculate a first angle with the cellular user equipment (UE1 or UE2) as a vertex, which is formed by the position of D2D Rx, the position of the cellular user equipment and the position of the base station BS, and determine that the transmission beam of the cellular user equipment covers the position of D2D Rx in a case that the first angle is less than a width of the transmission beam of the cellular user equipment. The first angle defined in the above way has a feature of pointing from the cellular user equipment to the base station BS and to D2D RX according to the definition. In addition, in a case that beamforming technology is used for communication between the base station and the cellular user equipment, it is considered that the transmission beam of the cellular user equipment has a feature of pointing to the base station BS. Therefore, using the above first angle and the directivity feature of the transmission beam of the cellular user equipment, it is determined whether D2D Rx is covered by the transmission beam of the cellular user equipment simply by determining whether the first angle is less than the width of the transmission beam of the cellular user equipment, without further accurately determining the direction of the transmission beam of the cellular user equipment.

For example, the determination unit 540 may calculate, based on the position information of D2D Rx, the position information of the cellular user equipment UE1 and the position of the base station BS (which may be known from the base station BS), the first angle (i.e., the angle θ in FIG. 7) with UE1 as an vertex, which is formed by D2D Rx, the cellular user equipment UE1 and the base station BS, and determine that the first angle is less than the width of the transmission beam of UE1 (for example, the width of the transmission beam may be known from the base station BS), so as to determine that the transmission beam of UE1 covers the position of D2D Rx. The determination unit 540 may calculate the first angle with UE2 as a vertex (i.e., an angle formed by D2D Rx, UE2 and BS) in a similar manner for the cellular user equipment UE2, and determine that the first angle is greater than the width of the transmission beam of UE2. In this way, in this example, the determination unit 540 determines that UE1 meets the second standard and UE2 does not meet the second standard.

The determination unit 540 may further perform determination based on the beam-coverage-based third standard, that is, determine whether the reception beam of D2D Rx covers the positions of the cellular user equipment UE1 and UE2. As a specific example of the third standard, the determination unit 540 may calculate a second angle with D2D Rx as a vertex, which is formed by the position of the cellular user equipment (UE1 or UE2), the position of D2D Rx and the position of D2D Tx, and determine that the reception beam of D2D Rx covers the cellular user equipment in a case that the second angle is less than the width of the reception beam of D2D Rx. The second angle defined in the above way has a feature of pointing from D2D Rx to the cellular user equipment and to D2D Tx according to the definition. In addition, in a case that D2D Rx and D2D Tx use beams for communication, it is considered that the reception beam of D2D Rx has the feature of pointing to D2D Tx. Therefore, using the above second angle and the directivity feature of the reception beam of D2D Rx, it is determined whether the cellular user equipment is covered by the reception beam of D2D Rx simply by determining whether the second angle is less than the width of the reception beam of D2D Rx, without further accurately determining the direction of the reception beam of D2D Rx.

As an example, the determination unit 540 may calculate, based on position information of the cellular user equipment UE1, D2D Rx and D2D Tx, the second angle (not shown in the Figure) with D2D Rx as a vertex, which is formed by UE1, D2D Rx and D2D Tx, and determine that the second angle is less than the width of the reception beam of D2D Rx (for example, the width of the reception beam of D2D Rx may be known from the base station BS). Similarly, the determination unit 540 may calculate a second angle (formed by UE2, D2D Rx and D2D Tx) with D2D Rx as a vertex for the cellular user equipment UE2 in a similar manner, and determine that the second angle is greater than the width of the reception beam of D2D Rx. In this way, in this example, the determination unit 540 determines that UE1 meets the third standard and UE2 does not meet the third standard.

After obtaining the determination results based on the above first standard to third standard, the determination unit 540 may determine the device under measurement that meets one or more of the standards as the expected high-interference device under measurement. For example, the determination unit 540 may adopt a relatively strict final standard or a relatively loose standard. As an example of the relatively strict final standard, it may be considered that a device under measurement that meets the first standard and second standard, a device under measurement that meets the first standard and the third standard, or even a device under measurement that meets the first standard to the third standard is determined as the high-interference device under measurement. In the exemplary scenario shown in FIG. 7, under the strict standard, the determination unit 540 only determines UE1 as the high-interference device under measurement. Alternatively, the determination unit 540 may adopt a relatively loose final standard. For example, a device under measurement that meets any one of the first standard to the third standard may be determined as the high-interference device under measurement. For another example, the determination unit 540 may adopt a larger distance threshold D′ₜₕ in the distance-based first standard, so that in addition to UE1, UE2 where a distance between UE2 and D2D Tx is slightly larger and the distance is less than the distance threshold D′ₜₕ is also determined as the high-interference device under measurement.

In the example described above with reference to FIG. 7, the determination unit 540 performs determination based on the first standard to the third standard according to the position information of the D2D receiver, and the position information of the devices under measurement, optional beam information (beam width) and the position information of the base station. Next, an example of obtaining the position information of the D2D receiver and the position information of the devices under measurement through estimation is briefly described.

As an example only, in an exemplary case such as the case of millimeter wave cellular network shown in FIG. 7, for each device, an estimated position of the device may be obtained by estimation based on three-dimensional beamforming performed by the base station BS as position information of the device. When the base station BS performs the three-dimensional beamforming, a uniform rectangular array (URA) is configured to provide beamforming of two spatial dimensions including azimuth and pitch simultaneously. In practice, a base station antenna is often arranged at a high position, so that it may be assumed that positions of user equipment including the D2D equipment and the cellular user equipment are determined by downlink three-dimensional beamforming at the base station. That is, a coverage region of a three-dimensional beam in which the user equipment is arranged may be determined based on the three-dimensional beam used by the base station. In addition, for example, a center position of the coverage region may be determined as the estimated position for the user equipment. In the example shown in FIG. 7, the estimated positions of the user equipment are schematically represented by circles with different gray levels respectively, to indicate that different user equipment are respectively in coverage ranges of different three-dimensional beams (these beams are represented by sectors with different gray levels in FIG. 7) of the base station BS.

It should be noted that the above case of obtaining relevant information based on the three-dimensional beamforming performed by the base station BS is only an example. The determination unit 540 may obtain a variety of information for performing determination based on the first standard to the third standard, such as the above information, in various manners, which is not limited in the present disclosure.

After the determination unit 540 of the electronic device 500 determines the expected high-interference device under measurement, for example, in the above manner, accordingly, the generation unit 510 of the electronic device 500 may generate, according to the determination result of the determination unit 540, appropriate interference measurement configuration information about the reference signal of each device under measurement according to different levels of detail, so as to reduce the signaling overhead of the communication unit 530 subsequently transmitting the information. Here, the preferred configuration of the reference signals of the signals under measurement configured by the configuration unit in the second configuration example described above with reference to FIG. 3 is followed, that is, reference signals occupying continuous or concentrated time and frequency resources are pre-configured for at least part or even all of the devices under measurement (including the cellular user equipment and the D2D transmitter).

In a preferred embodiment, the interference measurement configuration information generated by the generation unit 510 may include: specific measurement configuration information, for indicating time and frequency resources of the reference signal of the expected high-interference device under measurement; and overall measurement configuration information, for indicating a union of time and frequency resources of the reference signals of all devices under measurement. In an embodiment, the specific configuration information may further indicate sequence information of the reference signal of the expected high-interference device under measurement.

Referring to the specific configuration example of time and frequency resources of the SRS reference signal shown in FIG. 4, further details of the interference measurement configuration information generated by the generation unit 510 in this preferred embodiment are described in combination with the example. For the user 1 under measurement to the user 8 under measurement configured with the SRS reference signals occupying continuous time and frequency resources in the example shown in FIG. 4, it is assumed that only the device 1 under measurement is determined as the expected high-interference device under measurement by the determination unit 540. Accordingly, a set K of all devices under measurement from the device 1 under measurement to the device 8 under measurement may be grouped. A first group K_{A} includes the expected high-interference device under measurement. In this example, K_{A} only includes the device 1 under measurement. A second group K_{B}=K−K_{A} includes devices under measurement other than the expected high-interference device under measurement. In this example, K_{B} includes the device 2 under measurement to the device 8 under measurement.

In this case, the specific configuration information generated by the generation unit 510 may indicate time and frequency resources of the reference signal of each high-interference device under measurement in the expected first group K_{A}, and optionally may further indicate sequence information of each reference signal. In a case of the example shown in FIG. 4, the specific configuration information generated by the generation unit 510 may indicate that a time domain starting position of the SRS reference signal of the device 1 under measurement is an OFDM symbol numbered 12, the number of continuous OFDM symbols is 1, a frequency domain starting position is a subcarrier numbered 0, the number of combs is equal to 2, a comb offset is 0, and the number of occupied resource blocks is 1. In an embodiment, the specific configuration information may further indicate a root index and a cyclic shift of the ZC sequence of the SRS reference signal of the device 1 under measurement.

In addition, the overall configuration information generated by the generation unit 510 may indicate the union of time and frequency resources of the reference signals of all devices K under measurement. In the example shown in FIG. 4, the union of time and frequency resources of the SRS reference signals of all devices K under measurement, i.e. the device 1 under measurement to the device 8 under measurement, includes that: a time domain starting position of the SRS reference signal of the device 1 under measurement is an OFDM symbol numbered 12, the number of continuous OFDM symbols is 2, a frequency domain starting position is a subcarrier numbered 0, and the number of resource blocks is 1. For each device under measurement in the set K_{B} of the devices under measurement other than the expected high-interference device under measurement, the specific measurement configuration information of the reference signal of the device under measurement is not indicated separately, and the measurement configuration of the reference signals of such devices under measurement in the set K_{B} is overall covered by the above union for all devices K under measurement.

When the communication unit 530 transmits the interference measurement configuration information generated in the above manner and including the specific measurement configuration information and the overall measurement configuration information, the signaling overhead for transmitting the interference measurement configuration information can be reduced. It is assumed that in a case of transmitting the specific measurement configuration information for all devices under measurement, a signaling overhead of all measurement configuration information is expressed as OH₁=M, where M represents the total number of the devices under measurement. However, for the form of interference measurement configuration information in this preferred embodiment, a signaling overhead of all measurement configuration information is expressed as OH₂=1+MP, where P represents a ratio of the number of expected high-interference device under measurement to the total number of the devices under measurement. Therefore, a ratio of the two signaling overheads is expressed as OH₂/OH₁=1/M+P. It can be seen that in a case of a large value of M and a small value of P, the signaling overheads can be greatly reduced. FIG. 8 is a schematic diagram for explaining the signaling overhead of the interference measurement configuration information generated by the generation unit in the third configuration example of the electronic device, and shows the comparison of the two signaling overheads calculated in the above manner in this exemplary scenario, that is, in a case of M=8 and P=⅛, the signaling overhead of transmitting the specific measurement configuration information of all devices under measurement is expressed as OH₁=8. In addition, the signaling overhead of generating the interference measurement configuration information including the specific measurement configuration information and the overall measurement configuration information in the manner according to this preferred embodiment is greatly reduced to OH₂=1+8*⅛=2.

As described later in detail in the configuration example of the electronic device at the D2D receiver side, after receiving the interference measurement configuration information including the specific measurement configuration information and the overall measurement configuration information, the electronic device at the D2D receiver side may measure the interference of the high-interference device under measurement to the D2D receiver according to the received specific measurement configuration information, and measure the overall interference of all devices under measurement to the D2D receiver according to the received overall measurement configuration information, so as to determine the interference from the devices under measurement other than the expected high-interference device under measurement (i.e., the interference from these other devices under measurement). The electronic device at the D2D receiver side may provide an interference measurement report based on the determined interference, and transmit the interference measurement report to the electronic device 5) at the base station side.

In an example, the interference measurement report received by the communication unit 520 of the electronic device 500 may include at least a first part and a second part. The first part is for indicating whether the D2D receiver receives interference from the expected high-interference device under measurement. The second part is for indicating whether the D2D receiver receives interference from the device under measurement other than the expected high-interference device under measurement. Here (and in the context of the present disclosure), the expression that the D2D receiver “receives interference” from a device under measurement means that the D2D receiver suffers interference from the device under measurement. As an example, the interference measurement report received by the communication unit 520 may be in a form of a bit sequence. A length of a first part of the bit sequence is the number Kₐ of the expected high-interference devices under measurement (i.e., the number of all devices under measurement in K_{A}). Each bit of the first part indicates whether the D2D receiver receives interference from a corresponding expected high-interference device under measurement. A length of a second part of the bit sequence is 1. The second part indicates whether interference is received from the device under measurement other than the expected high-interference device under measurement. In this example, the received interference measurement report may be {1, 0}, where the first bit of 1 indicates that interference is received from only the expected high-interference device 1 under measurement, and the second bit of 0 indicates that no interference is received from devices 2 to 8 under measurement other than the expected high-interference device under measurement.

In a variant embodiment, in a case that the second part of the interference measurement report received by the communication unit 520 of the electronic device 500 indicates that the D2D receiver receives interference from other devices under measurement than the expected high-interference device under measurement (for example, in a case that the above example sequence is {1,1}), the determination unit 540 of the electronic device 500 may further determine an expected secondary-high-interference device under measurement other than the expected high-interference device under measurement. Here, compared with the strict standard used when determining the high-interference device under measurement for the first time, the determination unit 540 may adopt a loose standard to determine the secondary-high-interference device. For example, when determining the expected high-interference device under measurement for the first time, the determination unit 540 may determine the device 1 under measurement that meets both the first standard and the second standard described above or the device 1 under measurement that meets both the first standard and the third standard as the high-interference device under measurement. When determining the secondary-high-interference device under measurement, for example, a device under measurement other than the expected high-interference device under measurement, that is, a device under measurement meeting any one of the first standard to the third standard, such as the device 2 under measurement, may be determined as the secondary-high-interference device under measurement.

For the secondary-high-interference device under measurement determined by the determination unit 540, the generation unit 510 may transmit additional specific measurement configuration information to the D2D receiver. The additional specific measurement configuration information indicates specific measurement configuration of the reference signal of the expected secondary-high-interference device under measurement other than the expected high-interference device under measurement. Details of the additional specific measurement configuration information may be with reference to the above description of the specific measurement configuration information, and are not repeated here.

Accordingly, after receiving the additional specific measurement configuration information, the electronic device at the D2D receiver side may additionally measure the interference of the expected secondary-high-interference device under measurement to the D2D receiver according to the received additional specific measurement configuration information, and generate an additional interference measurement report in combination with the interference previously obtained, and transmit the additional interference measurement report to the electronic device 500 at the base station side.

In an example, the communication unit 520 of the electronic device 500 may receive the additional interference measurement report from the D2D receiver. The additional interference measurement report includes a first part and a second part. The first part is for indicating whether interference is received from the expected secondary-high-interference device under measurement. The second part is for indicating whether interference is received from the device under measurement other than the expected high-interference device under measurement and the expected secondary-high-interference device under measurement. As an example, the additional interference measurement report received by the communication unit 520 may be in a form of a bit sequence similar to that used in the interference measurement report. A length of a first part of the bit sequence is the number kₐ₂ of the expected secondary-high-interference device under measurement. Each bit of the first part indicates whether the D2D receiver receives interference from a corresponding expected secondary-high-interference device under measurement. A length of a second part of the bit sequence is 1, and the second part indicates whether interference is received from device under measurement other than the expected high-interference device under measurement and the expected secondary-high-interference device under measurement.

According to the description of this variant embodiment, it can be understood that if the determination unit 540 omits a device under measurement that actually causes interference when determining the expected high-interference device under measurement for the first time, subsequently, it is required to determine the expected secondary-high-interference device under measurement in a similar iterative manner, transmit an additional specific measurement configuration information and receive the additional measurement report. Therefore, in order to avoid omitting the device under measurement that actually causes interference when determining the expected high-interference device under measurement for the first time, a relatively loose standard may be adopted when determining the expected high-interference device under measurement for the first time. For example, a device under measurement that meets any one of the first standard to the third standard may be determined as the expected high-interference device under measurement. In an embodiment, a relatively large distance threshold may be used in the distance based first standard.

An example in which the measurement configuration information generated by the generation unit 510 includes the specific measurement configuration information about the high-interference device under measurement and the overall measurement configuration information about all devices under measurement is described above. In this case, as discussed above, devices under measurement (including the cellular user equipment and the D2D transmitter) are preferably pre-configured with reference signals occupying continuous time and frequency resources (for example, the SRS reference signals described with reference to FIG. 4), so that the signaling overhead of measurement configuration information can be effectively reduced.

On the other hand, as described above, in practical application, a reference signal occupying continuous or concentrated time and frequency resources may be pre-configured for a part of the devices under measurement in the cell such as all cellular user equipment, and a reference signal occupying other time and frequency resources may be pre-configured for other device under measurement in the cell such as the D2D transmitter that may cause interference.

In this case, in a variant embodiment, the determination unit 540 may first determine D2D transmitters in all devices under measurement. It can be understood that the determination unit 540 may determine the D2D transmitters in the devices under measurement based on knowledge of the electronic device 500 at the base station side about the cellular user equipment and the D2D device within the coverage of the base station, which is not limited in the present disclosure.

In this variant embodiment, the interference measurement configuration information generated by the generation unit 510 and transmitted by the communication unit may include, for example, D2D measurement configuration information for indicating time and frequency resources of the reference signal of the D2D transmitter in the devices under measurement; and overall measurement configuration information for indicating a union of time and frequency resources of reference signals of all cellular user equipment in the devices under measurement. In this case, the D2D measurement configuration information is similar to the specific measurement configuration information for the high-interference device under measurement described above, except that the D2D measurement configuration information corresponds to the D2D transmitter in the devices under measurement rather than the high-interference device under measurement. In addition, the overall measurement configuration information in this embodiment is similar to the overall measurement configuration information described above, except that the overall measurement configuration information in this embodiment corresponds to all cellular user equipment in the devices under measurement rather than all devices under measurement. Based on the above understanding, those skilled in the an can appropriately apply all aspects of the above described embodiments to this embodiment, so that this embodiment is not repeated here.

In an example application of this variant embodiment, the reference signal of the D2D transmitter in the devices under measurement may include a channel state information reference signal (CSI-RS) or a demodulation reference signal (DM-RS). The reference signal of the cellular user equipment in the devices under measurement includes a sounding reference signal. In other words, the configuration unit 530 may pre-configure SRS reference signals occupying continuous or concentrated time and frequency resources for all cellular user equipment in the devices under measurement, and pre-configure CSI-RS or DM-RS that can be used for the D2D transmitter as a reference signal of the D2D transmitter.

In this variant embodiment, a high-interference device under measurement in the cellular user equipment under measurement may also be considered. That is, in this variant embodiment, the determination unit 540 may further determine expected high-interference cellular user equipment in the devices under measurement. Accordingly, the interference measurement configuration information generated by the generation unit 510 and transmitted by the communication unit 520 may further include specific measurement configuration information for indicating time and frequency resources of a reference signal of the expected high-interference cellular user equipment. The specific measurement configuration information is different from the specific measurement configuration information in the previously described preferred embodiment only in that the specific measurement configuration information in this variant embodiment corresponds to the expected high-interference cellular user equipment in the devices under measurement, rather than all the expected high-interference devices under measurement. Based on the above understanding, those skilled in the art can appropriately apply all aspects of the specific measurement configuration information in the basic embodiment described above to this variant embodiment, which is not repeated here.

The third configuration example of the electronic device at the base station side according to an embodiment of the present disclosure is described above. As described above, in the third configuration example, based on the expected high-interference device under measurement determined by the determination unit, the generation unit may generate interference measurement configuration information with an appropriate level of detail, thereby reducing the signaling overhead of transmitting the interference measurement configuration information. It should be noted that although the expected high-interference device under measurement is obtained here based on the determination made by the determination unit, in practical application, the electronic device may obtain the expected high-interference device under measurement in other manners (for example, receiving a prediction result about the high-interference device under measurement obtained in any appropriate way from an external device having a function of the determination unit), which is not limited in the present disclosure.

2.4 Fourth Configuration Example of Electronic Device at Base Station Side

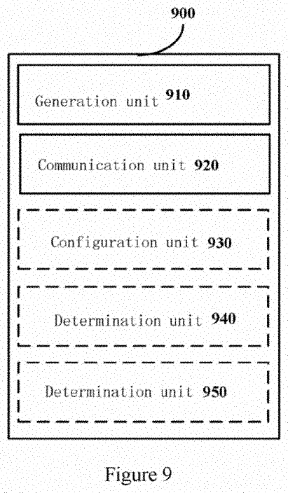

FIG. 9 is a block diagram showing a fourth configuration example of the electronic device at the base station side according to an embodiment of the present disclosure. The fourth configuration example shown in FIG. 9 is an improvement based on the first configuration example, the second configuration example, or the third configuration example. Therefore, the following description is based on the first configuration example to the third configuration example, which is not repeated here.

As shown in FIG. 9, the electronic device 900 may include a generation unit 910, a communication unit 920, a configuration unit 930, and a determination unit 940, which are similar to the units 510 to 540 in the electronic device 500 shown in FIG. 5. Here, it is to be emphasized that the configuration unit 930 and the determination unit 940 shown in the dotted boxes are optional units and may be omitted from the functional architecture of the electronic device 900 shown in FIG. 9. The electronic device 900 further includes a control unit 950, which is configured to perform scheduling or power control for the D2D receiver and/or the device under measurement according to the interference measurement report received from the D2D receiver, so as to reduce the interference of the device under measurement to the D2D receiver. The control unit 950 may perform the above scheduling or power control in various appropriate manners, including but not limited to scheduling the device under measurement causing interference to communicate on different time-frequency resources, reducing the transmission power of the device under measurement, and the like. The present disclosure is not limited in this aspect and is not further described here.

Configuration examples of the electronic device at the base station side according to the embodiments of the present disclosure are described above. As described above, the electronic device at the base station side according to the embodiments of the present disclosure is capable of providing the D2D receiver with appropriate interference measurement configuration information for the D2D receiver to measure interference based on the received interference measurement configuration information. In addition, the electronic device is capable of acquiring an interference measurement report from the D2D receiver. Therefore, the electronic device at the base station side according to the embodiments of the present disclosure understands the interference to the D2D receiver, thereby providing the possibility of reducing the interference to the D2D receiver through scheduling or power control.

### 3. Configuration Example of Electronic Device at D2D Receiver Side

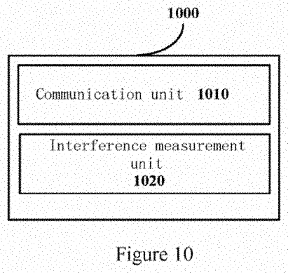

Corresponding to the above configuration examples of the electronic device at the base station side, a configuration example of the electronic device at the D2D receiver side according to the embodiments of the present disclosure is described in detail below. FIG. 10 is a block diagram showing a configuration example of the electronic device at the D2D receiver side according to the embodiments of the present disclosure.

As shown in FIG. 10, the electronic device 1000 may include a communication unit 1010 and an interference measurement unit 1020.

Here, units of the electronic device 1000 may be included in a processing circuit. It should be noted that the electronic device 1000 may include one processing circuitry or multiple processing circuitry. Further, the processing circuitry may include various separate functional units to perform various functions and/or operations. It should be noted that these functional units may be physical entities or logical entities, and units with different names may be implemented by one physical entity. In addition, the electronic device 1000, for example, may include the D2D receiver, or may be implemented as another electronic device attached to the D2D receiver.

According to the embodiments of the present disclosure, the communication unit 1010 may receive interference measurement configuration information from the base station. The interference measurement configuration information indicates a configuration of a reference signal to be transmitted by a device under measurement, with which a D2D receiver multiplexes wireless communication resources, in a cell where the D2D receiver is located. For example, the cell where the D2D receiver is located may indicate a service coverage of the base station, such as a coverage range of the base station. The interference measurement unit 1020 may measure, as interference to the D2D receiver, a reception signal at the D2D receiver of the reference signal transmitted by the device under measurement according to the received interference measurement configuration information to obtain an interference measurement report. The communication unit 1010 may transmit the interference measurement report to the base station.

According to the embodiments of the present disclosure, the electronic device 1000 may measure, as the interference to the D2D receiver, the reception signal at the D2D receiver of the reference signal transmitted by the device under measurement according to the interference measurement configuration information received from the base station, to obtain the interference measurement report and transmit the interference measurement report to the base station.

Preferably, the wireless communication resources multiplexed by the D2D receiver with the device under measurement are uplink communication resources.

In a case that the uplink communication resources are multiplexed in D2D communication, the device under measurement, with which the D2D receiver multiplexes wireless communication resources, in a cell where the D2D receiver is located may include uplink cellular user equipment. In addition, in a case that there is more than one pair of D2D devices in the cell where the D2D receiver is located, the device under measurement may further include a D2D transmitter other than a D2D transmitter corresponding to a subject D2D receiver. In the following, in a case that it is unnecessary to distinguish the cellular user equipment and other D2D transmitter in the devices under measurement, the cellular user equipment and the D2D transmitter collectively referred to as the device under measurement.

The electronic device 1000 according to the embodiments of the present disclosure may be applied to a scenario where beamforming is used on both a network side (for example, a base station) and a user equipment side (for example, cellular user equipment and D2D equipment) of a millimeter wave cellular network. Therefore, in an embodiment of the present disclosure, the D2D receiver and the device under measurement may respectively use specific beams (i.e. directional beams rather than omnidirectional beams) for communication

In an exemplary embodiment, the reference signal to be transmitted by the device under measurement, with which the D2D receiver multiplexes wireless communication resources, in the cell where the D2D receiver is located may include a sounding reference signal.

Preferred embodiments of the electronic device 1000 are further described below.

In a preferred embodiment, as in the configuration example of the electronic device 500 at the base station side described above with reference to FIG. 5, the base station pre-configures reference signals occupying continuous or concentrated time and frequency resources for each device under measurement (including the cellular user equipment and the D2D transmitter), determines an expected high-interference device under measurement, and generates interference measurement configuration information with an appropriate level of detail

In this case, the interference measurement configuration information received by the communication unit 1010 of the electronic device 1000 at the D2D receiver side may include: specific measurement configuration information and overall measurement configuration information. The specific measurement configuration information is for indicating time and frequency resources of the reference signal of the expected high-interference device under measurement. The overall measurement configuration information is for indicating a union of time and frequency resources of the reference signals of all devices under measurement. In an embodiment, the specific configuration information may further indicate sequence information of the reference signal of the expected high-interference device under measurement.

Accordingly, the interference measurement unit 1020 of the electronic device 1000 may be configured to: measure, as interference of the high-interference device under measurement to the D2D receiver, a reception signal at the D2D receiver of the reference signal of the high-interference device under measurement according to the received specific measurement configuration information; and measure, as overall interference of all devices under measurement to the D2D receiver, reception signals at the D2D receiver of the reference signals of all devices under measurement according to the received overall measurement configuration information.

For example, the interference measurement unit 1020 may measure a reception power of the reception signal at the D2D receiver of the reference signal of the device under measurement according to the received measurement configuration information as an indicator of the interference of the device under measurement to the D2D receiver. More specifically, in an example of this preferred embodiment, the interference measurement unit 1020 may measure a reception power of the reception signal at the D2D receiver of the reference signal of each expected high-interference device under measurement according to the received specific measurement configuration information as an indicator of the interference of the expected high-interference device under measurement to the D2D receiver. In addition, the interference measurement unit 1020 may measure a sum of reception power of the reception signals at the D2D receiver of the reference signals of all devices under measurement according to the received overall measurement configuration information as an indicator of the interference of all devices under measurement to the D2D receiver.

Further details of a specific example of such measurement by the interference measurement unit 1020 are described below. In this example, all L devices under measurement are represented by a set K. The reference signal of each device under measurement is in a form of SRS reference signal. The specific measurement configuration information received by the communication unit indicates the time and frequency resources of the reference signals of expected high-interference devices under measurement in the set K, i.e. all devices under measurement in a first group of devices under measurement K_{A}, and additionally indicates sequence information of the reference signal of each device under measurement. In addition, the overall measurement configuration information received by the communication unit indicates a union of time and frequency resources of the reference signals of all devices under measurement in the set K. The communication unit does not receive information of specific time and frequency resources of the reference signals of the device under measurement other than the expected high-interference device under measurement, i.e. devices under measurement in a second group K_{B}=K−K_{A}.

On the one hand, for an (i)th expected high-interference device under measurement (hereinafter referred to as an (i)th device under measurement) in K_{A}, since the specific measurement configuration information received by the communication unit indicates the time and frequency resources and preferred sequence information of the reference signal of the (i)th device under measurement, reception power of the reference signal may be calculated according to the following equations (1) and (2), as an indicator of the interference of the (i)th expected high-interference device under measurement to the D2D receiver.

r_{t,i}=F_{N}_{_{ZC}}⁻¹(r_{j,i}⊙s*ᵢ) equation (1).

The equations (1) is used for transforming the reception signal of the (i)th device under measurement to a time domain. r_{j,i} represents a reception signal extracted from a corresponding time and frequency position according to the time and frequency resources of the reference signal of the device under measurement indicated in the received specific measurement configuration information. Sᵢ represents an SRS sequence with a length of N_{ZC} of the device under measurement obtained according to the time and frequency resources and the sequence information of the reference signal of the device under measurement indicated in the specific measurement configuration information. F_{N}⁻¹ represents an IDFT matrix of the N_{ZC} point, through which a signal is transformed into a signal r_{t,i} at the time domain.

$${I}_{i} = {( {r}_{t , i}^{*} ⊙ {r}_{t , i} )}^{T} w - \frac{W}{L} {σ}_{n}^{2} . \qquad equation ( 2 )$$

The equation (2) is used for calculating the reception power of the reception signal of the reference signal of the (i)th device under measurement based on the signal r_{t,i} at the time domain. w represents a rectangular window function and W represents a window length. Considering power leakage of IDFT, in practice, w=[1, 1, . . . , 1, 0, . . . , 0, 1]^{T} may be set. σₙ² represents total noise power at the receiver, which may be measured by the interference measurement unit 1020 in various appropriate manners. In this way, the interference Iᵢ caused by the (i)th expected high-interference device under measurement in K_{A} is determined.

As an alternative, for the (i)th expected high-interference device under measurement in K_{A}, if the specific measurement configuration information received by the communication unit 1010 only indicates the time and frequency resources of the reference signal of the (i)th device under measurement and does not indicate the sequence information, the interference measurement unit 1020 may directly measure reception power I′ᵢ of the reception signal r_{j,i} extracted from the corresponding time and frequency position as the interference of the (i)th device under measurement to the D2D receiver.

On the other hand, for all devices under measurement in K, since the overall measurement configuration information received by the communication unit 1010 indicates the union of the time and frequency resources of the reference signals of the devices under measurement, the interference measurement unit 1020 may directly extract an overall reception signal r_{f} from a time and frequency position corresponding to the union, and measure reception power Iₛᵤₘ the reception signal r_{f} as an indicator representing total interference caused by the reference signals to the receiver. Here, since it is unnecessary to separately calculate the reception power of the reception signal of each device under measurement according to the time and frequency resources of the SRS reference signal of the device under measurement, the processing is simplified.

In an embodiment, if the noise at the receiver is obtained in advance by measurement or the like, accurate measurement results may be obtained by subtracting a noise from the above measured reception power Iₛᵤₘ and I′ᵢ. In addition, preferably, in order to reduce the influence of the noise at the receiver, the base station side may cause each device under measurement to use a long SRS sequence as a reference signal to improve the power of the reference signal, thereby improving the measurement performance.

Some details of an specific example in which the interference measurement unit 1020 measures the reception power of the reception signal at the D2D receiver of the reference signal of the device under measurement based on the obtained interference measurement configuration information as an indicator of the interference of the device under measurement to the D2D receiver are described in detail. It should be noted that as long as the interference measurement configuration information obtained by the communication unit 1010 includes the specific measurement configuration information and the overall measurement configuration information as described above, the interference measurement unit 1020 obtains, based on such information in various appropriate manners, the reception power of the reference signal of each expected high-interference device under measurement and the total reception power of the reference signals of all devices under measurement. The present disclosure is not limited to the details in the above specific examples, and the details are not repeated here.

The interference measurement unit 1020 may determine the interference of device under measurement other than the high-interference device under measurement to the D2D receiver based on, for example, the interference of the high-interference device under measurement and the overall interference of all devices under measurement that are measured in the above manner. Taking a case in which the reception power is calculated as the indicator of the interference as an example, the interference measurement unit 1020 may calculate reception power Iₒₜₕₑᵣₛ at the D2D receiver of the reference signal of the device under measurement other than the high-interference device under measurement according to the following equation (3), as the indicator of the interference:

$${I}_{others} = {I}_{sum} - {\sum }_{i ∈ {K}_{A}} {I}_{i} . \qquad equation ( 3 )$$

Based on the determined various interferences (the indicators of interference), the interference measurement unit 1020 may determine: whether the interference Iᵢ of each high-interference device under measurement is greater than a first threshold Iₜₕ₁, and whether the interference Iₒₜₕₑᵣₛ of device under measurement other than the high-interference device under measurement is greater than a second threshold Iₜₕ₂.

Here, in an embodiment, in the case that the reception power serves as the indicator of the interference, the interference measurement unit 1020 may be further configured to: appropriately configure a power threshold such as the above first threshold Iₜₕ₁ and second threshold Iₜₕ₂ based on the reception power of the D2D receiver receiving the D2D signal and the noise power at the D2D receiver. For example, in a case that the reception power of the D2D receiver receiving the D2D signal is relatively large, relatively large first threshold Iₜₕ₁ and second threshold Iₜₕ₂ may be set. In a case that the noise power at the D2D receiver is relatively large, relatively large first threshold Iₜₕ₁ and second threshold Iₜₕ₂ may be set.

In a case that the measured interference Iᵢ of the high-interference device under measurement is greater than the first threshold Iₜₕ₁, the interference measurement unit 1020 determines that the D2D receiver receives interference from the high-interference device under measurement. In addition, in a case that the determined interference Iₒₜₕₑᵣₛ of device under measurement other than the high-interference device under measurement is greater than the second threshold Iₜₕ₂, the interference measurement unit determines that the D2D receiver receives interference from device under measurement other than the high-interference device under measurement.

The interference measurement unit 1020 may, for example, generate an interference measurement report based on the determination of such first threshold and second threshold. The interference measurement report at least includes a first part and a second part. The first part is for indicating whether the D2D receiver receives interference from the expected high-interference device under measurement. The second part is for indicating whether the D2D receiver receives interference from device under measurement other than the high-interference device under measurement.

As an example, the interference measurement report generated by the interference measurement unit 1020 may be in a form of a bit sequence. A length of the first part is the number kₐ of the expected high-interference devices under measurement, and each bit indicates whether the D2D receiver receives interference from a corresponding expected high-interference device under measurement. A length of the second part is 1, which indicates whether interference is received from device under measurement other than the high-interference device under measurement. Compared with a case of separately indicating whether interference is received from each of all devices under measurement (the length of the sequence is the number L of all devices under measurement), the interference measurement report generated by the interference measurement unit 1020 can reduce a signaling overhead.

In a modified embodiment of the preferred embodiment described above, in a case that the second part of the interference measurement report generated by the interference measurement unit 1020 indicates that the D2D receiver receives interference from device under measurement other than the high-interference device under measurement, the communication unit 1010 of the electronic device 1000 may further receive additional specific measurement configuration information from the base station. The additional specific measurement configuration information indicates time and frequency resources of the reference signal of expected secondary-high-interference device under measurement other than the expected high-interference device under measurement.

In this case, the interference measurement unit 1020 may further be configured to: measure the reception signal at the D2D receiver of the reference signal of the secondary-high-interference device under measurement according to the received additional specific measurement configuration information, as the interference of the secondary-high-interference device under measurement to the D2D receiver, and determine, based on the measured interference of the high-interference device under measurement, the measured interference of the secondary-high-interference device under measurement and the measured overall interference of all devices under measurement, the interference of device under measurement other than the high-interference device under measurement and the secondary-high-interference device under measurement to the D2D receiver.

Here, the interference measurement unit 1020 may, in a manner similar to the above described manner in which the interference of the expected high-interference device under measurement is determined, determine the interference of the expected secondary-high-interference device under measurement to the D2D receiver and determine the interference of device under measurement other than the high-interference device under measurement and the secondary-high-interference device under measurement to the D2D receiver. As an example, the interference measurement unit 1020 obtains the interference Iⱼ of each secondary-high-interference device under measurement j (j∈K′_{A}, where K′_{A} is a set of the expected secondary-high-interference device under measurement), and obtains the interference Iₒₜₕₑᵣₛ′ of device under measurement other than the high-interference device under measurement and the secondary-high-interference device under measurement to the D2D receiver:

$${I}_{others}^{′} = {I}_{sum} - {\sum }_{i ∈ {K}_{A}} {I}_{i} - {\sum }_{j ∈ {K}_{A}} {I}_{j} . \qquad equation ( 4 )$$

Accordingly, based on the determined various interferences (the indicators of interference), the interference measurement unit 1020 may determines: whether the interference Iⱼ of each secondary-high-interference device under measurement is greater than the first threshold Iₜₕ₁, and whether the interference I′ₒₜₕₑᵣₛ of device under measurement other than the high-interference device under measurement and the secondary-high-interference device under measurement is greater than the second threshold Iₜₕ₂.

In a case that the measured interference of the secondary-high-interference device under measurement is greater than the first threshold Iₜₕ₁, the interference measurement unit 1020 determines that the D2D receiver receives interference from the secondary-high-interference device under measurement. In addition, in a case that the determined interference of device under measurement other than the high-interference device under measurement and the secondary-high-interference device under measurement is greater than the second threshold Iₜₕ₂, the interference measurement unit determines that the D2D receiver receives interference from device under measurement other than the high-interference device under measurement and the secondary-high-interference device under measurement.

Accordingly, in this modified embodiment, the interference measurement unit 1020 may further be configured to transmit an additional interference measurement report to the base station. The additional interference measurement report includes a first part and a second part. The first part is for indicating whether interference is received from the expected secondary-high-interference device under measurement. The second part is for indicating whether interference is received from device under measurement other than the high-interference device under measurement and the expected secondary-high-interference device under measurement.

As an example, the additional interference measurement report generated by the interference measurement unit 1020 may be in a form of a bit sequence. A length of the first part is the number kₐ₂ of the expected secondary-high-interference devices under measurement, and each bit indicates whether the D2D receiver receives interference from a corresponding expected secondary-high-interference device under measurement. A length of the second part is 1, which indicates whether interference is received from device under measurement other than the high-interference device under measurement and the expected secondary-high-interference device under measurement.

An example in which the measurement configuration information received by the communication unit includes the specific measurement configuration information about the high-interference device under measurement and the overall measurement configuration information about all devices under measurement is described above. In this case, as discussed above, the base station side pre-configures the reference signal occupying continuous time and frequency resources (for example, the SRS reference signal described with reference to FIG. 4) for each device under measurement (including the cellular user equipment and the D2D transmitter), so as to effectively reduce the signaling overhead of the measurement configuration information, and simplify the processing of determining interference and reduce the computation amount in the electronic device 1000 at the D2D receiver side.

On the other hand, in practical applications, the base station side may only pre-configures reference signals occupying continuous or concentrated time and frequency resources for a part of devices under measurement in the cell, such as all cellular user equipment, and pre-configures reference signals occupying other time and frequency resources for other devices under measurement in the cell, such as D2D transmitters that may cause interference.

In this case, in another modified embodiment of the preferred embodiments described above, the interference measurement configuration information received by the communication unit 1010 in the electronic device 1000 at the D2D receiver side may include, for example, D2D measurement configuration information and overall measurement configuration information. The D2D measurement configuration information is for indicating time and frequency resources of the reference signal of the D2D transmitter in the devices under measurement. The overall measurement configuration information is for indicating a union of time and frequency resources of the reference signals of all cellular user equipment in the devices under measurement.

Accordingly, the interference measurement unit 1020 of the electronic device 1000 may further be configured to: measure, according to the received D2D measurement configuration information, a reception signal at a subject D2D receiver of the reference signal of the D2D transmitter in the devices under measurement, as interference of the D2D transmitter in the devices under measurement to the subject D2D receiver; and measure, according to the received overall measurement configuration information, reception signals at the subject D2D receiver of the reference signals of all cellular user equipment in the devices under measurement, as overall interference of all cellular user equipment in the devices under measurement to the subject D2D receiver.

Here, the determination of the interference of the D2D transmitter by the interference measurement unit is similar to the determination of the interference of the high-interference device under measurement described above, except that here the interference of the D2D transmitter in the devices under measurement rather than the interference of the high-interference device under measurement is determined. In addition, the determination of the overall interference of all cellular user equipment by the interference measurement unit is similar to the determination of the overall interference of all devices under measurement described above, except that here the overall interference of all cellular user equipment in the devices under measurement rather than the overall interference of all devices under measurement is determined. Based on understanding of these differences, those skilled in the art may appropriately apply various aspects of the preferred embodiments described above to this modified embodiment, which is not repeated here.

In an example of this modified embodiment, the reference signal of the D2D transmitter in the devices under measurement may include a channel state information reference signal (CSI-RS) or a demodulation reference signal (DM-RS). The reference signal of the cellular user equipment in the devices under measurement includes a sounding reference signal. In other words, the base station side may pre-configure SRS reference signals occupying continuous or concentrated time and frequency resources for all cellular user equipment in the devices under measurement, and pre-configure CSI-RS or DM-RS that can be used by the D2D transmitter for the D2D transmitter as the reference signal of the D2D transmitter.

In this modified embodiment, optionally, high-interference device under measurement in the cellular user equipment under measurement may also be considered. That is, in this modified embodiment, optionally, the communication unit 1010 in the electronic device 1000 at the D2D receiver side may further be configured to receive specific measurement configuration information from the base station. The specific measurement configuration information is for indicating time and frequency resources of a reference signal of an expected high-interference cellular user equipment, and the interference measurement unit 1020 may determine interference of the expected high-interference cellular user equipment based on this information. Those skilled in the art may appropriately apply relevant processing related to the specific measurement configuration in the preferred embodiments described above to this modified embodiment, which is not repeated here.

The preferred embodiments and the modified embodiments of the electronic device at the D2D receiver side according to the embodiments of the present disclosure are described above, which correspond to the configuration examples of the electronic device at the base station side described above with reference to FIG. 2, FIG. 3, FIG. 5 and FIG. 7, especially the third configuration example shown in FIG. 5. As described above, in these preferred embodiments, the electronic device at the D2D receiver side may measure interference based on the interference measurement configuration information with an appropriate level of detail received through the communication unit, and generate a measurement report, thereby reducing the processing amount of interference measurement and the signaling overhead for transmitting the interference measurement report. For various details not described here, reference may be made to the various configuration examples of the electronic device at the base station side described above.

### 4. Example of Information Interaction Process

[4-1. First Example of Information Interaction Process]

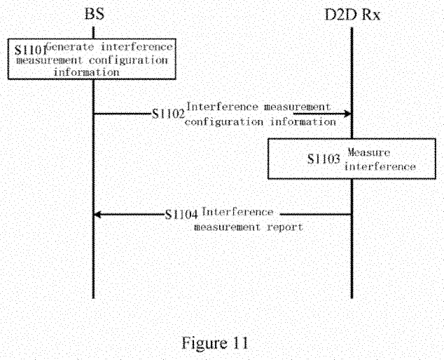

FIG. 11 is a flowchart showing a first example of an information interaction process according to an embodiment of the present disclosure. In the example, the electronic device 200 at the base station side described above with reference to FIG. 2 may serve as a base station BS, and the electronic device 1000 at the D2D receiver side described above with reference to FIG. 10 may serve as a D2D receiver (D2D Rx).

As shown in FIG. 11, in step S1101, the base station BS generates interference measurement configuration information, which indicates ae configuration of a reference signal to be transmitted by a device under measurement, with which the D2D Rx multiplexes wireless communication resources, in a cell where the D2D Rx is located. Then, the base station BS transmits the interference measurement configuration information to the D2D Rx in step S1102. Next, in step S1103, the D2D RX measures a reception signal at the D2D Rx of the reference signal transmitted by the device under measurement according to the interference measurement configuration information as interference to the D2D Rx, and generates an interference measurement report. Then, in step S1104, the D2D Rx transmits the interference measurement report to the base station BS.

[4-2. Second Example of Information Interaction Process]

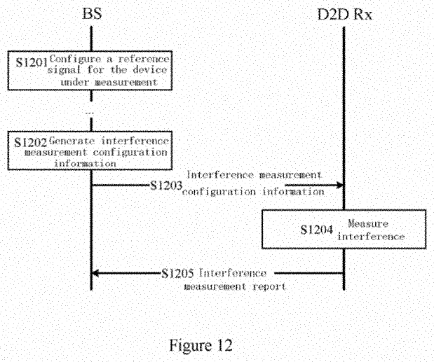

FIG. 12 is a flowchart showing a second example of the information interaction process according to an embodiment of the present disclosure. In the example, the electronic device 300 at the base station side described above with reference to FIG. 3 may serve as a base station BS, and the electronic device 1000 at the D2D receiver side described above with reference to FIG. 10 may serve as a D2D receiver (D2D Rx).

The flow of the example shown in FIG. 12 is different from the flow of the example shown in FIG. 11 in that the flow of the example shown in FIG. 12 further includes step S1201 in which the base station pre-configures a reference signal for the device under measurement. In addition, steps S1202 to S1205 in the flow of example shown in FIG. 12 are respectively similar to steps S1101 to S1104 in the flow of example shown in FIG. 11, which is not repeated.

As shown in FIG. 12, in step S1101, the base station BS pre-configures a reference signal of the device under measurement. Preferably, the base station BS may pre-configure reference signals occupying continuous or concentrated time and frequency resources for at least some devices under measurement in the cell. For example, the base station BS may configure a sounding reference signal occupying continuous or concentrated time and frequency resources as the reference signal.

[4-3. Third Example of Information Interaction Process]

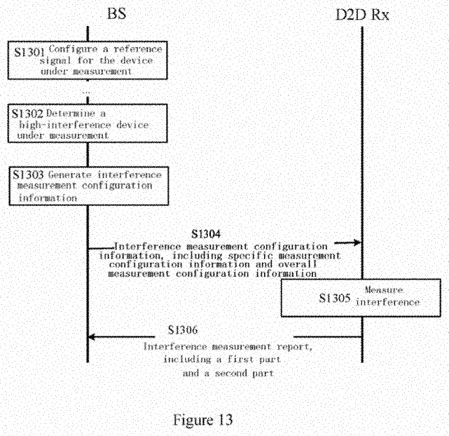

FIG. 13 is a flowchart showing a third example of the information interaction process according to an embodiment of the present disclosure. In the example, the electronic device 500 at the base station side described above with reference to FIG. 5 may serve as a base station BS, and the electronic device 1000 at the D2D receiver side described above with reference to FIG. 10 may serve as a D2D receiver (D2D Rx).

The flow of the example shown in FIG. 13 is different from the flow of the example shown in FIG. 12 in that the flow of the example shown in FIG. 13 further includes step S1302 in which the base station determines an expected high-interference device under measurement. In addition, steps S1301, S1303 and S1306 in the flow of the example shown in FIG. 12 are roughly similar to steps S1201 to S1105 in the flow of the example shown in FIG. 12, and only differences between these steps are described below.

As shown in FIG. 13, in step S1302, the base station BS determines the expected high-interference device under measurement. Next, in step S1303, the base station BS may generate interference measurement configuration information with an appropriate level of detail based on the determination result in step S1302, and transmit the information to the D2D Rx in the next step S1304. The interference measurement configuration information here may include: specific measurement configuration information and overall measurement configuration information. The specific measurement configuration information is for indicating time and frequency resources of the reference signal of the expected high-interference device under measurement. The overall measurement configuration information is for indicating a union of time and frequency resources of reference signals of all devices under measurement.

Next, in step S1305, the D2D RX may perform measurement based on the received measurement configuration information. Specifically, the D2D RX may measure interference of the expected high-interference device under measurement to the D2D Rx based on the received specific measurement configuration information, and measure overall interference of all devices under measurement to the D2D receiver based on the received overall measurement configuration information. The D2D Rx may generate an interference measurement report based on the measurement and transmit the report to the base station BS in step S1306. Here, as an example, the measurement report includes a first part and a second part. The first part is for indicating whether the D2D receiver receives interference from the expected high-interference device under measurement. The second part is for indicating whether the D2D receiver receives interference from device under measurement other than the expected high-interference device under measurement.

It should be noted that the flow of the above example is also applicable to the following modified embodiment in which: in the processing from step S1302 to step S1306, the “high-interference device under measurement” is replaced by “D2D receiver in the device under measurement”, and the “all devices under measurement” is replaced by “all cellular user equipment in the devices under measurement”. Such a modified embodiment is described in detail in the above configuration example of the device, and is not repeated here.

[4-4. Fourth Example of information Interaction Process]

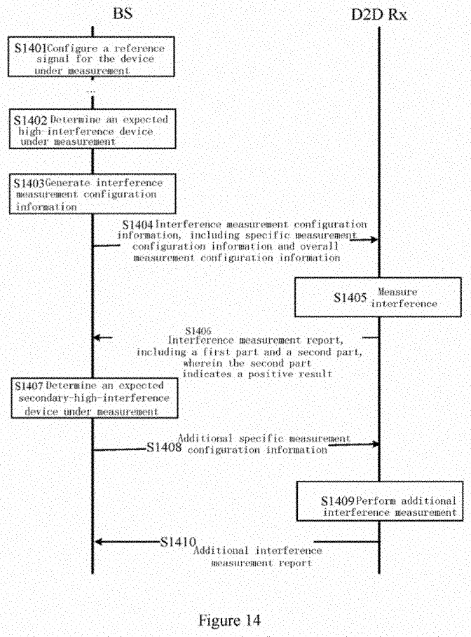

FIG. 14 is a flowchart showing a fourth example of the information interaction process according to an embodiment of the present disclosure. In the example, the electronic device 500 at the base station side described above with reference to FIG. 5 may serve as a base station BS, and the electronic device 1000 at the D2D receiver side described above with reference to FIG. 10 may serve as a D2D receiver (D2D Rx).

Steps S1401 to S1405 in the flow of the example shown in FIG. 14 are respectively similar to steps S1301 to S1305 in the flow of the example shown in FIG. 13, so that description of steps S1401 to S1405 is omitted.

The differences between the flow of the example shown in FIG. 14 and the flow of the example shown in FIG. 13 include step S1406, in which the second part of the transmitted interference measurement report is defined to indicate a positive result. In other words, the interference measurement report transmitted from the D2D Rx to the base station BS in step S1406 indicates that interference is received from device under measurement other than the expected high-interference device under measurement.

In this case, in step S1407, the base station BS determines expected secondary-high-interference device under measurement other than the expected high-interference device under measurement, and transmits additional specific measurement configuration information to the D2D Rx in step S1408. The additional specific measurement configuration information indicates a specific measurement configuration of the reference signal of the expected secondary-high-interference device under measurement.

Accordingly, in step S1409, the D2D Rx performs additional interference measurement based on the additional specific measurement configuration information to generate an additional interference measurement report, and transmits the additional interference measurement report to the base station BS in step S14010. The additional interference measurement report here may include a first part and a second part. The first part is for indicating whether interference is received from the expected secondary-high-interference device under measurement. The second part is for indicating whether interference is received from device under measurement other than the expected high-interference device under measurement and the expected secondary-high-interference device under measurement.

[4-5. Fifth Example of Information Interaction Process]

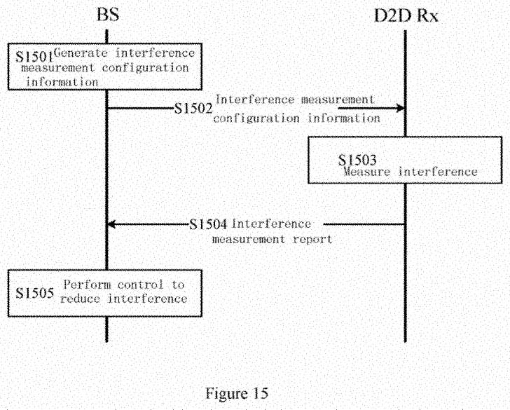

FIG. 15 is a flowchart showing a fifth example of the information interaction process according to an embodiment of the present disclosure. In the example, the electronic device 900 at the base station side described above with reference to FIG. 9 may serve as a base station BS, and the electronic device 1000 at the D2D receiver side described above with reference to FIG. 10 may serve as a D2D receiver (D2D Rx).

Steps S1501 to S1503 in the flow of the example shown in FIG. 15 are respectively similar to steps S1101 to S1103 in the flow of the example shown in FIG. 11, so that description of steps S1501 to S1503 is omitted. The flow of the example shown in FIG. 15 is different from the flow of the example shown in FIG. 11 in that the flow of the example shown in FIG. 15 further includes step S1504 in which the base station BS performs scheduling or power control for the D2D receiver and/or the device under measurement according to the interference measurement report received from the D2D receiver, to reduce the interference of the device under measurement to the D2D receiver.

It should be noted that the information interaction processes shown in FIGS. 11 to 15 are only examples. Those skilled in the art may also make appropriate modifications to the examples according to the principle of the present disclosure and actual conditions, and such modifications should apparently be considered to fall within the scope of the present disclosure.

### 5. Method Embodiment

Corresponding to the above device embodiments, the following method embodiments are provided according to the present disclosure.

First, a method for wireless communication performed by the electronic device (i.e., the electronic device 200, the electronic device 300, the electronic device 500, or the electronic device 900) at the base station side according to an embodiment of the present disclosure is described.

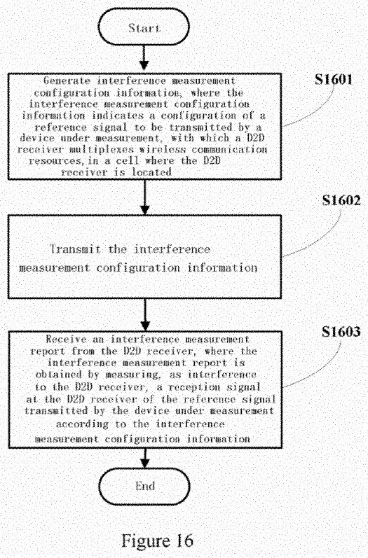

FIG. 16 is a flowchart showing a process example of a method for wireless communication at a based station side according to an embodiment of the present disclosure.

As shown in FIG. 16, in step S1601, interference measurement configuration information is generated. The interference measurement configuration information indicates a configuration of a reference signal to be transmitted by a device under measurement, with which a D2D receiver multiplexes wireless communication resources, in a cell where the D2D receiver is located.

Next, in step S1602, the interference measurement configuration information is transmitted to the D2D receiver.

Next, in step S1603, an interference measurement report is received from the D2D receiver. The interference measurement report is obtained by measuring, as interference to the D2D receiver, a reception signal at the D2D receiver of the reference signal transmitted by the device under measurement according to the interference measurement configuration information.

In an embodiment, the wireless communication resources multiplexed by the D2D receiver with the device under measurement include uplink communication resources. In an embodiment, the device under measurement includes uplink cellular user equipment. In an embodiment, the device under measurement further includes a D2D transmitter other than a D2D transmitter corresponding to a subject D2D receiver. Preferably, the D2D receiver and the device under measurement respectively use specific beams for communication.

In an embodiment, the method for wireless communication may further include: pre-configure the reference signal for each device under measurement in the cell. Preferably, the reference signals of at least some devices under measurement in the cell are pre-configured to occupy continuous or concentrated time and frequency resources. Preferably, the reference signal includes a sounding reference signal.

In an embodiment, the interference measurement configuration information generated in step S1601 may include specific measurement configuration information and overall measurement configuration information. The specific measurement configuration information is for indicating time and frequency resources of the reference signal of an expected high-interference device under measurement. The overall measurement configuration information is for indicating a union of time and frequency resources of the reference signals of all devices under measurement. In an embodiment, the specific configuration information further indicates sequence information of the reference signal of the expected high-interference device under measurement.

In an embodiment, the interference measurement report received in step S1603 includes at least a first part and a second part. The first part is for indicating whether the D2D receiver receives interference from the expected high-interference device under measurement. The second part is for indicating whether the D2D receiver receives interference from device under measurement other than the expected high-interference device under measurement.

In an embodiment, the method for wireless communication may further include: transmitting, in a case that the second part of the received interference measurement report indicates that the D2D receiver receives interference from device under measurement other than the expected high-interference device under measurement, additional specific measurement configuration information to the D2D receiver. The additional specific measurement configuration information indicates a specific measurement configuration of the reference signal of expected secondary-high-interference device under measurement other than the expected high-interference device under measurement. In addition, in an embodiment, the method for wireless communication may further include: receiving an additional interference measurement report from the D2D receiver. The additional interference measurement report includes a first part and a second part. The first part is for indicating whether interference is received from the expected secondary-high-interference device under measurement. The second part is for indicating whether interference is received from device under measurement other than the expected high-interference device under measurement and the expected secondary-high-interference device under measurement.

In an embodiment, the method for wireless communication may further include: determining the expected high-interference device under measurement based on position information of the D2D receiver and position information of the device under measurement in the cell. As an example, in a case that a distance between the D2D receiver and the device position information of the D2D receiver and position information of the device under measurement in the cell is less than a predetermined threshold, the device under measurement may be determined as the expected high-interference device under measurement. Further, if the D2D receiver and the device under measurement respectively use specific beams for communication, the device under measurement may be determined as the expected high-interference device under measurement in a case that a transmission beam of the D2D receiver covers the position of the device under measurement and/or a reception beam of the device under measurement covers the position of the D2D receiver.

In addition, in an embodiment, the interference measurement configuration information generated in step S1601 may include: D2D measurement configuration information and overall measurement configuration information. The D2D measurement configuration information is for indicating time and frequency resources of the reference signal of the D2D transmitter in the devices under measurement. The overall measurement configuration information is for indicating a union of time and frequency resources of reference signals of all cellular user equipment in the devices under measurement. In an embodiment, in this case, the interference measurement configuration information may further include: specific measurement configuration information for indicating time and frequency resources of the reference signal of the expected high-interference cellular user equipment. As an example, the reference signal of the D2D transmitter in the devices under measurement includes a channel state information reference signal or a demodulation reference signal, and the reference signal of the cellular user equipment in the devices under measurement includes a sounding reference signal.

In an embodiment, the method for wireless communication may further include: performing scheduling or power control for the D2D receiver and/or the device under measurement according to the interference measurement report received from the D2D receiver, to reduce the interference of the device under measurement to the D2D receiver.

According to the embodiments of the present disclosure, the above method may be performed by the electronic device 200, the electronic device 300, the electronic device 500 or the electronic device 900 at the base station side according to the embodiments of the present disclosure. Therefore, all the previous embodiments of the electronic device 200, the electronic device 300, the electronic device 500 and the electronic device 900 are applicable to the method described here.

Next, a method for wireless communication performed by an electronic device (i.e., the electronic device 1000) at the D2D receiver side according to an embodiment of the present disclosure is described in detail.

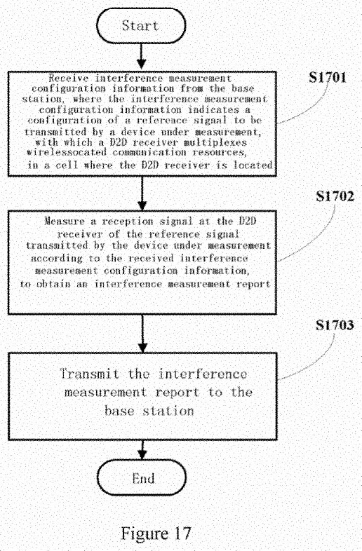

FIG. 17 is a flowchart showing a process example of a method for wireless communication at a D2D receiver side according to an embodiment of the present disclosure.

As shown in FIG. 17, in step S1701, interference measurement configuration information is received from the base station. The interference measurement configuration information indicates a configuration of a reference signal to be transmitted by a device under measurement, with which a D2D receiver multiplexes wireless communication resources, in a cell where the D2D receiver is located.

Next, in step S1702, a reception signal at the D2D receiver of the reference signal transmitted by the device under measurement is measured according to the received interference measurement configuration information, to obtain an interference measurement report.

Next, in step S1703, the interference measurement report is transmitted to the base station.

In an embodiment, the wireless communication resources multiplexed by the D2D receiver with the device under measurement include uplink communication resources. In an embodiment, the device under measurement includes uplink cellular user equipment. In an embodiment, the device under measurement further includes a D2D transmitter other than a D2D transmitter corresponding to a subject D2D receiver. Preferably, the D2D receiver and the device under measurement respectively use specific beams for communication. Preferably, the reference signal includes a sounding reference signal.

In an embodiment, the interference measurement configuration information received in step S1701 may include specific measurement configuration information and overall measurement configuration information. The specific measurement configuration information is for indicating time and frequency resources of the reference signal of an expected high-interference device under measurement. The overall measurement configuration information is for indicating a union of time and frequency resources of the reference signals of all devices under measurement. In an embodiment, the specific configuration information further indicates sequence information of the reference signal of the expected high-interference device under measurement.

In an embodiment, the measuring interference in step S1702 may include: measuring, according to the received specific measurement configuration information, a reception signal at the D2D receiver of the reference signal of the high-interference device under measurement, as interference of the high-interference device under measurement to the D2D receiver; and measuring, according to the received overall measurement configuration information, reception signals at the D2D receiver of the reference signals of all devices under measurement, as overall interference of all devices under measurement to the D2D receiver. In an embodiment, the interference of device under measurement other than the high-interference device under measurement may be determined based on the measured interference of the high-interference device under measurement and overall interference of all devices under measurement.

In an embodiment, the measuring interference in step S1702 may further include: determining, in a case that the measured interference of the high-interference device under measurement is greater than the first threshold, that the D2D receiver receives interference from the high-interference device under measurement; and determining, in a case that the determined interference of device under measurement other than the high-interference device under measurement is greater than the second threshold, that the D2D receiver receives interference from device under measurement other than the high-interference device under measurement. Accordingly, the interference measurement report generated in step S1702 includes at least a first part and a second part. The first part is for indicating whether the D2D receiver receives interference from the expected high-interference device under measurement. The second part is for indicating whether the D2D receiver receives interference from device under measurement other than the expected high-interference device under measurement.

In an embodiment, the method for wireless communication further includes: receiving, in a case that the second part of the interference measurement report indicates that the D2D receiver receives interference from device under measurement other than the expected high-interference device under measurement, additional specific measurement configuration information from the base station. The additional specific measurement configuration information indicates a specific measurement configuration of the reference signal of expected secondary-high-interference device under measurement other than the expected high-interference device under measurement.

In an embodiment, the method for wireless communication may further include: measuring, according to the received additional specific measurement configuration information, a reception signal at the D2D receiver of the reference signal of the secondary-high-interference device under measurement, as the interference of the secondary-high-interference device under measurement to the D2D receiver; and determining, based on the measured interference of the high-interference device under measurement, the measured interference of the secondary-high-interference device under measurement and the measured overall interference of all devices under measurement, the interference of device under measurement other than the high-interference device under measurement and the secondary-high-interference device under measurement to the D2D receiver. In this case, in an embodiment, in a case that the measured interference of the secondary-high-interference device under measurement is greater than the first threshold, it may be determined that the D2D receiver receives interference from the secondary-high-interference device under measurement. In a case that the determined interference of device under measurement other than the high-interference device under measurement and the secondary-high-interference device under measurement is greater than the second threshold, it may be determined that the D2D receiver receives interference from device under measurement other than the high-interference device under measurement and the secondary-high-interference device under measurement.

In an embodiment, the method for wireless communication may further include: transmitting an additional interference measurement report to the base station. The additional interference measurement report includes a first part and a second part. The first part is for indicating whether interference is received from the expected secondary-high-interference device under measurement. The second part is for indicating whether interference is received from device under measurement other than the expected high-interference device under measurement and the expected secondary-high-interference device under measurement.

In addition, in an embodiment, the interference measurement configuration information received in step S1701 may include: D2D measurement configuration information and overall measurement configuration information. The D2D measurement configuration information is for indicating time and frequency resources of the reference signal of the D2D transmitter in the devices under measurement. The overall measurement configuration information is for indicating a union of time and frequency resources of reference signals of all cellular user equipment in the devices under measurement.

In this case, the measuring interference in step S1702 may include: measuring, according to the received D2D measurement configuration information, a reception signal at a subject D2D receiver of the reference signal of the D2D transmitter in the devices under measurement, as interference of the D2D transmitter in the devices under measurement to the subject D2D receiver; and measure, according to the received overall measurement configuration information, reception signals at the subject D2D receiver of the reference signals of all cellular user equipment in the devices under measurement, as overall interference of all cellular user equipment in the devices under measurement to the subject D2D receiver. As an example, the reference signal of the D2D transmitter in the devices under measurement includes a channel state information reference signal or a demodulation reference signal, and the reference signal of the cellular user equipment in the devices under measurement includes a sounding reference signal.

In an embodiment, the method for wireless communication may further include: measuring a reception power of the reception signal at the D2D receiver of the reference signal of the device under measurement according to the received measurement configuration information as an indicator of the interference of the device under measurement to the D2D receiver. Preferably, in a case that the measured reception power of the reception signal of the reference signal is greater than a power threshold, it is determined that the D2D receiver receives interference from the device under measurement. In addition, in an embodiment, the method for wireless communication may further include: configuring the power threshold based on reception power at the D2D receiver of a D2D signal and noise power at the D2D receiver.

According to the embodiments of the present disclosure, the above method may be performed by the electronic device 1000 according to the embodiments of the present disclosure, so that various aspects of the embodiments of the electronic device 1000 described above are applicable to the method described here.

### 6. Application Example

The technology according to the present disclosure may be applicable to various productions.

For example, the electronic devices 200, 300, 500 and 900 at the base station side may be implemented as any types of base station device, such as a macro eNB and a small eNB. The electronic devices may further be implemented as any types of gNB (a base station in a 5G system). The small eNB may be an eNB of a cell having a smaller coverage than a macro cell, such as a pico eNB, a micro eNB and a home (femto) eNB. Alternatively, the base station may be implemented as any other types of base stations, such as a NodeB and a base transceiver station (BTS). The base station may include: a main body (also referred to as a base station device) configured to control the wireless communication; and one or more remote radio heads (RRH) arranged at a different location from the main body.

In addition, the electronic devices 200, 300, 500 and 900 at the base station side may be implemented as any types of TRP. The TRP may have a function of transmitting and receiving. For example, the TRP may receive information from user equipment and a base station device and may further transmit information to user equipment and a base station device. In an example, the TRP may serve user equipment and may be controlled by a base station device. Further, the TRP may have a structure similar to that of a base station device described below or only have a structure related to information transmitting and receiving in the base station device.

The electronic device 1000 at the D2D receiver side may be various user equipment. The electronic device 1000 may be implemented as a mobile terminal (such as a smartphone, a tablet personal computer (PC), a notebook PC, a portable game terminal, a portable/dongle mobile router and a digital camera) or a vehicle terminal (such as a vehicle navigation device). The user equipment may further be implemented as a terminal performing machine to machine (M2M) communications (which is also referred to as a machine type communication (MTC) terminal). In addition, the user equipment may further be a wireless communication module (such as an integrated circuitry module including one wafer) mounted on each of the above terminals.

[Application Example of Base Station]

### First Application Example

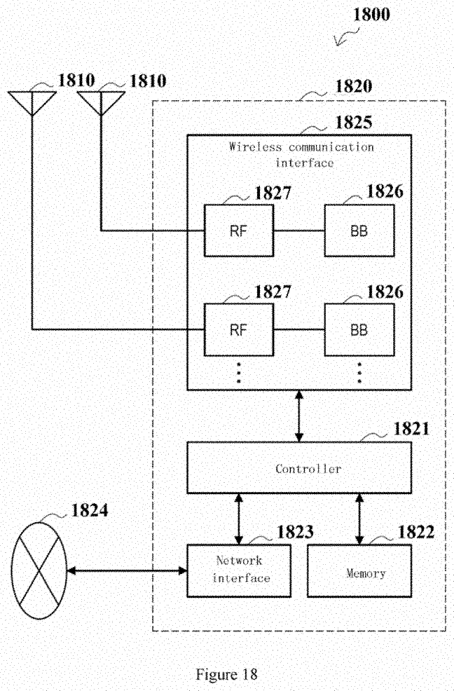

FIG. 18 is a block diagram showing a first example of exemplary configuration of an eNB to which technology according to the present disclosure may be applied. An eNB 1800 includes one or more antennas 1810 and a base station device 1820. Each of the antennas 1810 is connected to the base station device 1820 via a RF cable.

Each of the antennas 1810 includes a single antenna element or multiple antenna elements (such as multiple antenna elements included in a multiple-input multiple-output (MIMO) antenna), and is used for the base station device 1820 to transmit and receive a wireless signal. The eNB 1800 may include multiple antennas 1810, as shown in FIG. 18. For example, the multiple antennas 1810 may be compatible with multiple frequency bands used by the eNB 1800. Although FIG. 18 shows an example in which the eNB 1800 includes the multiple antennas 1810, the eNB 1800 may also include a single antenna 1810.

The base station device 1820 includes a controller 1821, a memory 1822, a network interface 1823 and a wireless communication interface 1825.

The controller 1821 may be, for example, a CPU or a DSP, and operate various functions of a high layer of the base station device 1820. For example, the controller 1821 generates a data packet according to data in a signal processed by the wireless communication interface 1825 and transmits the generated packet via the network interface 1823. The controller 1821 may bundle data from multiple baseband processors to generate a bundled packet and transmit the generated bundled packet. The controller 1821 may have a logic function that performs control such as wireless resource control, wireless bearer control, mobility management, admission control, and scheduling. The control may be performed in combination with a nearby eNB or core network node. The memory 1822 includes an RAM and an ROM, and stores a program executed by the controller 1821 and various types of control data (such as a terminal list, transmission power data and scheduling data).

The network interface 1823 is a communication interface via which the base station device 1820 is connected to a core network 1824. The controller 1821 may communicate with a core network node or another eNB via the network interface 1823. In this case, the eNB 1800 may be connected to the core network node or another eNB via a logical interface (such as an interface S1 and an interface X2). The network interface 1823 may also be a wired communication interface or a wireless communication interface for wireless backhaul line. If the network interface 1823 is the wireless communication interface, the network interface 1823 may use a frequency band for wireless communication higher than a frequency band used by the wireless communication interface 1825.

The wireless communication interface 1825 supports any cellular communication scheme (such as long term evolution (LTE) and LTE-Advanced), and provides wireless connection to a terminal located in a cell of the eNB 1800 via an antenna 1810. The wireless communication interface 1825 may include, for example, a (base band) BB processor 1826 and RF circuitry 1827. The BB processor 1826 may perform, for example, encoding/decoding, modulating/demodulating and multiplexing/de-multiplexing, and various types of signal processing of layers (such as L1, medium access control (MAC), radio link control (RLC) and packet data convergence protocol (PDCP)). Instead of the controller 1821, the BB processor 1826 may have a part or all of the above logic functions. The BB processor 1826 may be implemented as a memory storing a communication control program, or a module including a processor configured to execute a program and related circuitry. The function of the BB processor 1826 may be changed by updating the program. The module may be a card or blade inserted into a slot of the base station device 1820. Alternatively, the module may be a chip mounted on the card or the blade. Further, the RF circuitry 1827 may include, for example, a mixer, a filter or an amplifier, and transmits and receives a wireless signal via the antenna 1810.

As shown in FIG. 18, the wireless communication interface 1825 may include multiple BB processors 1826. For example, the multiple BB processors 1826 may be compatible with multiple frequency bands used by the eNB 1800. As shown in FIG. 18, the wireless communication interface 1825 may include multiple RF circuitry 1827. For example, the multiple RF circuitry 1827 may be compatible with multiple antenna elements. Although FIG. 18 shows an example in which the wireless communication interface 1825 includes multiple BB processors 1826 and multiple RF circuitry 1827, the wireless communication interface 1825 may include a single BB processor 1826 or single RF circuitry 1827.

In the eNB 1800 shown in FIG. 18, the communication units 220, 320, 520 and 920 in the electronic devices 200, 300, 500 and 900 described above with reference to FIG. 2, FIG. 3, FIG. 5 and FIG. 9 may be implemented by the wireless communication interface 1825. At least part of functions of the generation units 210, 310, 510, and 910 in the electronic devices 200, 300, 500, and 900 may be implemented by the controller 1821. For example, the controller 1821 may perform functions of the generation unit 210, 310, 510 or 910 by executing instructions stored in the memory 1822 to generate interference measurement configuration information. The interference measurement configuration information indicates a configuration of a reference signal to be transmitted by a device under measurement, with which a D2D receiver multiplexes wireless communication resources, in a cell where the D2D receiver is located. Similarly, at least part of functions of the configuration units 330 and 530 in the electronic devices 300 and 500, at least part of functions of the determination unit 540 in the electronic device 500, and at least part of functions of the control unit 950 in the electronic device 900 may also be implemented by the controller 1821, which is not repeated here.

### Second Application Example

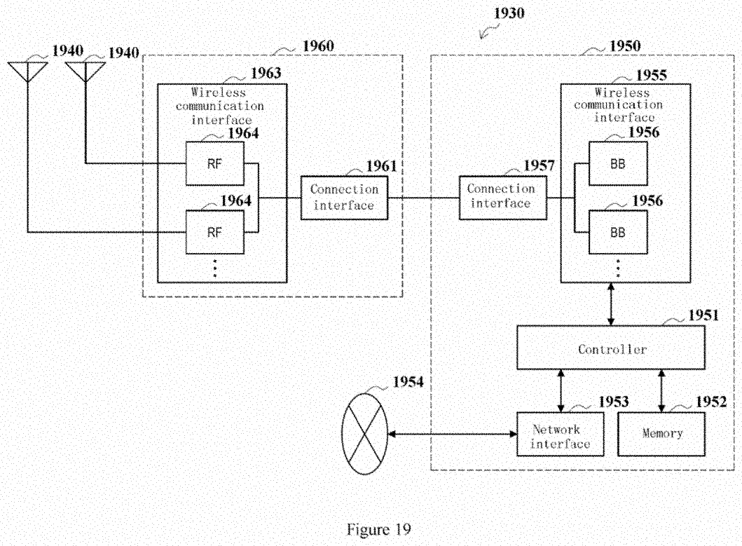

FIG. 19 is a block diagram showing a second example of the exemplary configuration of an eNB to which the technology of the present disclosure may be applied. An eNB 1930 includes one or more antennas 1940, a base station device 1950 and an RRH 1960. The RRH 1960 may be connected to each of the antennas 1940 via an RF cable. The base station device 1950 may be connected to the RRH 1960 via a high speed line such as an optical fiber cable.

Each of the antennas 1940 includes a single or multiple antenna elements (such as multiple antenna elements included in a MIMO antenna), and is used for the RRH 1960 to transmit and receive a wireless signal. As shown in FIG. 19, the eNB 1930 may include multiple antennas 1940. For example, the multiple antennas 1940 may be compatible with multiple frequency bands used by the eNB 1930. Although FIG. 19 shows an example in which the eNB 1930 includes the multiple antennas 1940, the eNB 1930 may also include a single antenna 1940.

The base station device 1950 includes a controller 1951, a memory 1952, a network interface 1953, a wireless communication interface 1955, and a connection interface 1957. The controller 1951, the memory 1952, and the network interface 1953 are respectively the same as the controller 1821, the memory 1822, and the network interface 1823 described with reference to FIG. 19.

The wireless communication interface 1955 supports any cellular communication schemes (such as LTE and LTE-advanced), and provides wireless communication with a terminal located in a sector corresponding to the RRH 1960 via the RRH 1960 and the antenna 1940. The wireless communication interface 1955 may generally include, for example, a BB processor 1956. Except for the BB processor 1956 being connected to RF circuitry 1964 of the RRH 1960 via the connection interface 1957, the BB processor 1956 is the same as the BB processor 1826 described with reference to FIG. 18. The wireless communication interface 1955 may include multiple BB processors 1956, as shown in FIG. 19. For example, the multiple BB processors 1956 may be compatible with multiple frequency bands used by the eNB 1930. Although FIG. 19 shows an example in which the wireless communication interface 1955 includes multiple BB processors 1956, the wireless communication interface 1955 may also include a single BB processor 1956.

The connection interface 1957 is an interface for connecting the base station device 1950 (the wireless communication interface 1955) to the RRH 1360. The connection interface 1957 may also be a communication module for communication in the above high speed line that connects the base station device 1950 (the wireless communication interface 1955) to the RRH 1960.

The RRH 1960 includes a connection interface 1961 and a wireless communication interface 1963.

The connection interface 1961 is an interface for connecting the RRH 1960 (the wireless communication interface 1963) to the base station device 1950. The connection interface 1961 may also be a communication module for communication in the above-described high speed line.

The wireless communication interface 1963 transmits and receives a wireless signal via the antenna 1940. The wireless communication interface 1963 may generally include, for example, the RF circuitry 1964. The RF circuitry 1964 may include, for example, a mixer, a filter, and an amplifier, and transmits and receives a wireless signal via the antenna 1940. The wireless communication interface 1963 may include multiple RF circuitry 1964, as shown in FIG. 19. For example, the multiple RF circuitry 1964 may support multiple antenna elements. Although FIG. 19 shows an example in which the wireless communication interface 1963 includes the multiple RF circuitry 1964, the wireless communication interface 1963 may also include single RF circuitry 1964.

In the eNB 1930 shown in FIG. 19, the communication units 220, 320, 520 and 920 in the electronic devices 200, 300, 500 and 900 described above with reference to FIG. 2, FIG. 3, FIG. 5 and FIG. 9 may be implemented by the wireless communication interface 1963. At least part of functions of the generation units 210, 310, 510, and 910 in the electronic devices 200, 300, 500, and 900 may be implemented by the controller 1951. For example, the controller 1951 may perform functions of the generation unit 210, 310, 510 or 910 by executing instructions stored in the memory 1952 to generate interference measurement configuration information. The interference measurement configuration information indicates a configuration of a reference signal to be transmitted by a device under measurement, with which a D2D receiver multiplexes wireless communication resources, in a cell where the D2D receiver is located. Similarly, at least part of functions of the configuration units 330 and 530 in the electronic devices 300 and 500, at least part of functions of the determination unit 540 in the electronic device 500, and at least part of functions of the control unit 950 in the electronic device 900 may also be implemented by the controller 1951, which is not repeated here.

[Application Example of User Equipment]

### First Application Example

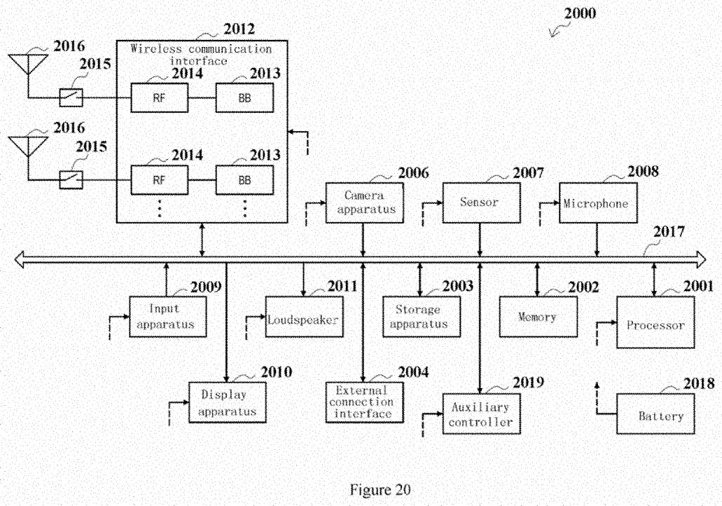

FIG. 20 is a block diagram showing an exemplary configuration of a smartphone 2000 to which technology according to the present disclosure may be applied. The smartphone 2000 includes a processor 2001, a memory 2002, a storage apparatus 2003, an external connection interface 2004, a camera apparatus 2006, a sensor 2007, a microphone 2008, an input apparatus 2009, a display apparatus 2010, a loudspeaker 2011, a wireless communication interface 2012, one or more antenna switches 2015, one or more antennas 2016, a bus 2017, a battery 2018 and an auxiliary controller 2019.

The processor 2001 may be, for example, a CPU or a system on chip (SoC), and controls functions of an application layer and another layer of the smartphone 2000. The memory 2002 includes an RAM and an ROM, and stores a program executed by the processor 2001 and data. The storage apparatus 2003 may include a storage medium such as a semiconductor memory and a hard disk. The external connection interface 2004 is an interface for connecting an external device (such as a memory card and a universal serial bus (USB) device) to the smartphone 2000.

The camera apparatus 2006 includes an image sensor (such as a charge coupled device (CCD) and a complementary metal oxide semiconductor (CMOS)), and generates a captured image. The sensor 2007 may include a group of sensors such as a measurement sensor, a gyro sensor, a geomagnetic sensor, and an acceleration sensor. The microphone 2008 converts sound that is inputted to the smartphone 2000 into an audio signal. The input apparatus 2009 includes, for example, a touch sensor configured to detect a touch on a screen of the display apparatus 2010, a keypad, a keyboard, a button, or a switch, and receives an operation or information inputted from a user. The display apparatus 2010 includes a screen (such as a liquid crystal display (LCD) and an organic light-emitting diode (OLED) display), and displays an output image of the smartphone 2000. The loudspeaker 2011 is configured to convert an audio signal outputted from the smartphone 2000 into sound.

The wireless communication interface 2012 supports any cellular communication scheme (such as LTE and LTE-Advanced), and performs wireless communications. The wireless communication interface 2012 may include, for example, a BB processor 2013 and RF circuitry 2014. The BB processor 2013 may perform, for example, coding/decoding, modulating/demodulating and multiplexing/de-multiplexing, and perform various types of signal processing for wireless communications. The RF circuitry 2014 may include, for example, a mixer, a filter and an amplifier, and transmits and receives a wireless signal via an antenna 2016. The wireless communication interface 2012 may be a chip module having the BB processor 2013 and the RF circuitry 2014 integrated thereon. As shown in FIG. 20, the wireless communication interface 2012 may include multiple BB processors 2013 and multiple RF circuitry 2014. Although FIG. 20 shows an example in which the wireless communication interface 2012 includes the multiple BB processors 2013 and the multiple RF circuitry 2014, the wireless communication interface 2012 may include a single BB processor 2013 or single RF circuitry 2014.

Besides the cellular communication scheme, the wireless communication interface 2012 may support an additional type of wireless communication scheme, such as a short-distance wireless communication scheme, a near field communication scheme and a wireless local area network (LAN) scheme. In this case, the wireless communication interface 2012 may include the BB processor 2013 and the RF circuitry 2014 for each wireless communication scheme.

Each of the antenna switches 2015 switches a connection destination of the antenna 2016 among multiple circuitry (such as circuitry for different wireless communication schemes) included in the wireless communication interface 2012.

Each of the antennas 2016 includes a single antenna element or multiple antenna elements (such as multiple antenna elements included in an MIMO antenna), and is used for the wireless communication interface 2012 to transmit and receive a wireless signal. The smartphone 2000 may include multiple antennas 2016, as shown in FIG. 20. Although FIG. 20 shows an example in which the smartphone 2000 includes the multiple antennas 2016, the smartphone 2000 may also include a single antenna 2016.

In addition, the smartphone 2000 may include an antenna 2016 for each type of wireless communication scheme. In this case, the antenna switches 2015 may be omitted from the configuration of the smartphone 2000.

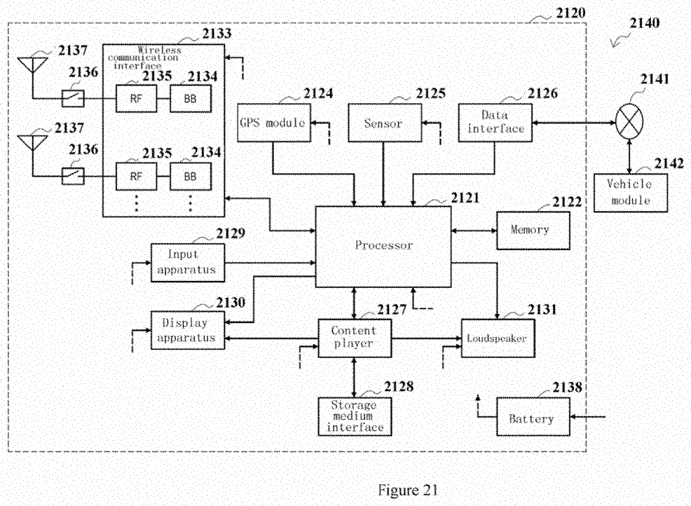

The processor 2001, the memory 2002, the storage apparatus 2003, the external connection interface 2004, the camera apparatus 2006, the sensor 2007, the microphone 2008, the input apparatus 2009, the display apparatus 2010, the loudspeaker 2011, the wireless communication interface 2012, and the auxiliary controller 2019 are connected to each other via the bus 2017. The battery 2018 supplies power to blocks of the smartphone 2000 shown in FIG. 21 via feeders that are partially shown with dashed lines in the drawings. The auxiliary controller 2019, for example, operates a minimum necessary function of the smartphone 2000 in a sleep mode.

In the smartphone 2000 shown in FIG. 20, the communication unit 1010 in the electronic device 1000 described above with reference to FIG. 10 may be implemented by the wireless communication interface 2012. At least part of functions of the interference measurement unit 1010 in the electronic device 1000 may be implemented by the processor 2001 or the auxiliary controller 2019. For example, the processor 2001 or the auxiliary controller 2019 may perform at least part of functions of the interference measurement unit 1010, for example, generate an interference measurement report, by executing instructions stored in the memory 2002 or the storage apparatus 2003. The interference measurement report is obtained by measuring, as interference to the D2D receiver, a reception signal at the D2D receiver of the reference signal transmitted by the device under measurement according to the received interference measurement configuration information.

### Second Application Example

FIG. 21 is a block diagram showing an example of schematic configuration of a vehicle navigation device 2120 to which the technology according to the present disclosure may be applied. The vehicle navigation device 2120 includes a processor 2121, a memory 2122, a global positioning system (GPS) module 2124, a sensor 2125, a data interface 2126, a content player 2127, a storage medium interface 2128, an input apparatus 2129, a display apparatus 2130, a loudspeaker 2131, a wireless communication interface 2133, one or more antenna switches 2136, one or more antennas 2137, and a battery 2138.

The processor 2121 may be, for example, a CPU or a SoC, and controls a navigation function and another function of the vehicle navigation device 2120. The memory 2122 includes an RAM and an ROM, and stores a program executed by the processor 2121, and data.

The GPS module 2124 uses a GPS signal received from a GPS satellite to calculate a location (such as a latitude, a longitude, and an altitude) of the vehicle navigation device 2120. The sensor 2125 may include a group of sensors such as a gyro sensor, a geomagnetic sensor, and an air pressure sensor. The data interface 2126 is connected to, for example, a vehicle network 2141 via a terminal that is not shown, and acquires data (such as vehicle speed data) generated by the vehicle.

The content player 2127 reproduces content stored in a storage medium (such as a CD and a DVD) that is inserted into the storage medium interface 2128. The input apparatus 2129 includes, for example, a touch sensor configured to detect a touch on a screen of the display apparatus 2130, a button, or a switch, and receives an operation or information inputted by a user. The display apparatus 2130 includes a screen such as a LCD or an OLED display, and displays an image of the navigation function or reproduced content. The loudspeaker 2131 outputs sound of the navigation function or the reproduced content.

The wireless communication interface 2133 supports any cellular communication scheme (such as LTE and LTE-Advanced), and performs wireless communications. The wireless communication interface 2133 may generally include, for example, a BB processor 2134 and RF circuitry 2135. The BB processor 2134 may perform, for example, encoding/decoding, modulating/demodulating, and multiplexing/de-multiplexing, and performs various types of signal processing for wireless communications. In addition, the RF circuitry 2135 may include, for example, a mixer, a filter, and an amplifier, and transmits and receives a wireless signal via the antenna 2137. The wireless communication interface 2133 may also be a chip module having the BB processor 2134 and the RF circuitry 2135 integrated thereon. The wireless communication interface 2133 may include multiple BB processors 2134 and multiple RF circuitry 2135, as shown in FIG. 21. Although FIG. 21 shows an example in which the wireless communication interface 2133 includes the multiple BB processors 2134 and the multiple RF circuitry 2135, the wireless communication interface 2133 may include a single BB processor 2134 or single RF circuitry 2135.

In addition to a cellular communication scheme, the wireless communication interface 2133 may support another type of wireless communication scheme such as a short-distance wireless communication scheme, a near field communication scheme, and a wireless LAN scheme. In that case, the wireless communication interface 2133 may include a BB processor 2134 and RF circuitry 2135 for each wireless communication scheme.

Each of the antenna switches 2136 switches a connection destination of the antenna 2137 among multiple circuitry (such as circuitry for different wireless communication schemes) included in the wireless communication interface 2133.

Each of the antennas 2137 includes a single short-distance wireless or multiple antenna elements (such as multiple antenna elements included in an MIMO antenna), and is used for the wireless communication interface 2133 to transmit and receive a wireless signal. The vehicle navigation device 2120 may include multiple antennas 2137, as shown in FIG. 21. Although FIG. 21 shows an example in which the vehicle navigation device 2120 includes the multiple antennas 2137, the vehicle navigation device 2120 may include a single antenna 2137.

Furthermore, the vehicle navigation device 2120 may include an antenna 2137 for each wireless communication scheme. In that case, the antenna switches 2136 may be omitted from the configuration of the vehicle navigation device 2120.

The battery 2138 supplies power to blocks of the vehicle navigation device 2120 shown in FIG. 21 via feeders that are partially shown as dashed lines in FIG. 21. The battery 2138 accumulates power supplied from the vehicle.

In the vehicle navigation device 2120 shown in FIG. 21, the communication unit 1010 in the electronic device 1000 described above with reference to FIG. 10 may be implemented by the wireless communication interface 2133. At least part of functions of the interference measurement unit 1010 in the electronic device 1000 may be implemented by the processor 2121. For example, the processor 2121 may perform at least part of functions of the interference measurement unit 1010, for example, generate an interference measurement report, by executing instructions stored in the memory 2122. The interference measurement report is obtained by measuring, as interference to the D2D receiver, a reception signal at the D2D receiver of the reference signal transmitted by the device under measurement according to the received interference measurement configuration information.

The technology of the present disclosure may also be implemented as a vehicle system (or a vehicle) 2140 including one or more blocks in the vehicle navigation device 2120, the vehicle network 2141, and a vehicle module 2142. The vehicle module 2142 generates vehicle data (such as a vehicle speed, an engine speed, and fault information), and outputs the generated data to the vehicle network 2141.

Preferred embodiments of the present disclosure are described above with reference to the drawings. However, the present disclosure is not limited to the above examples. Those skilled in the art may obtain various modifications and changes within the scope of the appended claims. It should understand that these modifications and changes fall within the technical scope of the present disclosure.

For example, a unit shown with a dashed-line block in functional block diagrams shown in the drawings is optional in a corresponding device. Further, optional functional units may be combined in a suitable manner to achieve required functions.

For example, in the above embodiments, multiple functions included in one unit may be achieved by separate devices. Alternately, in the above embodiments, multiple functions achieved by multiple units may be achieved by separate devices. In addition, one of the above functions may be achieved by multiple units. These configurations should be included in the technical scope of the present disclosure.

In this specification, the steps described in the flowcharts include not only processing performed in time series in the described order but also processing performed in parallel or individually instead of in time series. In addition, the steps performed in time series may be performed in a different order.

In addition, the present disclosure may have the following configurations.

(1) An electronic device, including:

processing circuitry configured to:

generate interference measurement configuration information indicating a configuration of a reference signal to be transmitted by a device under measurement, with which a D2D receiver multiplexes wireless communication resources, in a cell where the D2D receiver is located; and

transmit the interference measurement configuration information to the D2D receiver;

receive an interference measurement report from the D2D receiver, the interference measurement report being obtained by measuring, as interference to the D2D receiver, a reception signal at the D2D receiver of the reference signal transmitted by the device under measurement according to the interference measurement configuration information.

(2) The electronic device according to (1), where the wireless communication resources multiplexed by the D2D receiver with the device under measurement include uplink communication resources.

(3) The electronic device according to (2), where the device under measurement includes uplink cellular user equipment.

(4) The electronic device according to (3), where the device under measurement further includes a D2D transmitter other than a D2D transmitter corresponding to a subject D2D receiver.

(5) The electronic device according to any one of (1) to (4), where the D2D receiver and the device under measurement respectively use specific beams for communication.

(6) The electronic device according to any one of (1) to (4), where the processing circuitry is further configured to: pre-configure the reference signal for each device under measurement in the cell.

(7) The electronic device according to (1), where the processing circuitry is further configured to: pre-configure the reference signals of at least some devices under measurement in the cell to occupy continuous or concentrated time and frequency resources.

(8) The electronic device according to (7), where the reference signal includes a sounding reference signal.

(9) The electronic device according to (7), where the interference measurement configuration information includes:

specific measurement configuration information, for indicating time and frequency resources of the reference signal of an expected high-interference device under measurement; and

overall measurement configuration information, for indicating a union of time and frequency resources of the reference signals of all devices under measurement.

(10) The electronic device according to (9), where the specific configuration information further indicates sequence information of the reference signal of the expected high-interference device under measurement.

(11) The electronic device according to (9), where the received interference measurement report includes at least:

a first part for indicating whether the D2D receiver receives interference from the expected high-interference device under measurement; and

a second part for indicating whether the D2D receiver receives interference from device under measurement other than the expected high-interference device under measurement.

(12) The electronic device according to (11), where the processing circuitry is further configured to:

in a case that the second part of the received interference measurement report indicates that the D2D receiver receives interference from device under measurement other than the expected high-interference device under measurement, generate additional specific measurement configuration information and transmit the additional specific measurement configuration information to the D2D receiver; where the additional specific measurement configuration information indicates a specific measurement configuration of the reference signal of an expected secondary-high-interference device under measurement other than the expected high-interference device under measurement.

(13) The electronic device according to (12), where the processing circuitry is further configured to receive an additional interference measurement report from the D2D receiver, where the additional interference measurement report includes:

a first part for indicating whether interference is received from the expected secondary-high-interference device under measurement; and

a second part for indicating whether interference is received from a device under measurement other than the expected high-interference device under measurement and the expected secondary-high-interference device under measurement.

(14) The electronic device according to (9), where the processing circuitry is further configured to: determine the expected high-interference device under measurement based on position information of the D2D receiver and position information of the device under measurement in the cell.

(15) The electronic device according to (14), where the processing circuitry is further configured to: determine the device under measurement as the expected high-interference device under measurement, in a case that a distance between the D2D receiver and the device under measurement is less than a predetermined threshold.

(16) The electronic device according to (14), where the D2D receiver and the device under measurement respectively use specific beams for communication, and the processing circuitry is further configured to:

determine the device under measurement as the expected high-interference device under measurement in a case that a reception beam of the D2D receiver covers a position of the device under measurement and/or a transmission beam of the device under measurement covers a position of the D2D receiver.

(17) The electronic device according to (4), where the interference measurement configuration information includes:

D2D measurement configuration information for indicating time and frequency resources of the reference signal of the D2D transmitter in the devices under measurement; and

overall measurement configuration information for indicating a union of time and frequency resources of reference signals of all cellular user equipment in the devices under measurement.

(18) The electronic device according to (17), where the interference measurement configuration information further includes: specific measurement configuration information for indicating time and frequency resources of the reference signal of expected high-interference cellular user equipment.

(19) The electronic device according to (18), where:

the reference signal of the D2D transmitter in the devices under measurement includes a channel state information reference signal or a demodulation reference signal; and

the reference signal of the cellular user equipment in the devices under measurement includes a sounding reference signal.

(20) The electronic device according to (1), where the processing circuitry is further configured to:

perform scheduling or power control for the D2D receiver and/or the device under measurement according to the interference measurement report received from the D2D receiver, to reduce the interference of the device under measurement to the D2D receiver.

(21) An electronic device, including:

processing circuitry configured to:

receive, from a base station, interference measurement configuration information indicating a configuration of a reference signal to be transmitted by a device under measurement, with which a D2D receiver multiplexes wireless communication resources, in a cell where the D2D receiver is located;

measure, according to the received interference measurement configuration information, a reception signal at the D2D receiver of the reference signal transmitted by the device under measurement as interference to the D2D receiver to obtain an interference measurement report; and

transmit the interference measurement report to the base station.

(22) The electronic device according to (21), where the D2D receiver and the device under measurement multiplex uplink communication resources.

(23) The electronic device according to (22), where the device under measurement includes uplink cellular user equipment.

(24) The electronic device according to (23), where the device under measurement further includes a D2D transmitter other than a D2D transmitter corresponding to a subject D2D receiver.

(25) The electronic device according to any one of (21) to (24), where the D2D receiver and the device under measurement respectively use specific beams for communication.

(26) The electronic device according to any one of (21) to (24), where the reference signal includes a sounding reference signal.

(27) The electronic device according to any one of (21) to (24), where the received interference measurement configuration information includes:

specific measurement configuration information, for indicating time and frequency resources of the reference signal of an expected high-interference device under measurement; and

overall measurement configuration information, for indicating a union of time and frequency resources of the reference signals of all devices under measurement.

(28) The electronic device according to (27), where the specific configuration information further indicates sequence information of the reference signal of the expected high-interference device under measurement.

(29) The electronic device according to (27), where the processing circuitry is further configured to:

measure, a reception signal at the D2D receiver of the reference signal of the high-interference device under measurement according to the received specific measurement configuration information, as interference of the high-interference device under measurement to the D2D receiver; and

measure, reception signals at the D2D receiver of the reference signals of all devices under measurement according to the received overall measurement configuration information, as overall interference of all devices under measurement to the D2D receiver.

(30) The electronic device according to (29), where the processing circuitry is further configured to:

determine, based on the measured interference of the high-interference device under measurement and the measured overall interference of all devices under measurement, interference of device under measurement other than the high-interference device under measurement to the D2D receiver.

(31) The electronic device according to (30), where the processing circuitry is further configured to:

determine, in a case that the measured interference of the high-interference device under measurement is greater than a first threshold, that the D2D receiver receives interference from the high-interference device under measurement; and

determine, in a case that the determined interference of the device under measurement other than the high-interference device under measurement is greater than a second threshold, that the D2D receiver receives interference from the device under measurement other than the high-interference device under measurement.

(32) The electronic device according to (31), where the interference measurement report includes at least:

a first part for indicating whether the D2D receiver receives interference from the expected high-interference device under measurement; and

a second part for indicating whether the D2D receiver receives interference from device under measurement other than the expected high-interference device under measurement.

(33) The electronic device according to (32), where the processing circuitry is further configured to:

receive, in a case that the second part of the interference measurement report indicates that the D2D receiver receives interference from device under measurement other than the expected high-interference device under measurement, additional specific measurement configuration information from the base station, where the additional specific measurement configuration information indicates time and frequency resources of the reference signal of an expected secondary-high-interference device under measurement other than the expected high-interference device under measurement.

(34) The electronic device according to (33), where the processing circuitry is further configured to:

measure the reception signal at the D2D receiver of the reference signal of the secondary-high-interference device under measurement according to the received additional specific measurement configuration information, as the interference of the secondary-high-interference device under measurement to the D2D receiver, and

determine, based on the measured interference of the high-interference device under measurement, the measured interference of the secondary-high-interference device under measurement and the measured overall interference of all devices under measurement, the interference of device under measurement other than the high-interference device under measurement and the secondary-high-interference device under measurement to the D2D receiver.

(35) The electronic device according to (34), where the processing circuitry is further configured to:

determine, in a case that the measured interference of the secondary-high-interference device under measurement is greater than the first threshold, that the D2D receiver receives interference from the secondary-high-interference device under measurement; and

determine, in a case that the determined interference of the device under measurement other than the high-interference device under measurement and the secondary-high-interference device under measurement is greater than the second threshold, that the D2D receiver receives interference from the device under measurement other than the high-interference device under measurement and the secondary-high-interference device under measurement.

(36) The electronic device according to (35), where the processing circuitry is further configured to transmit an additional interference measurement report to the base station, where the additional interference measurement report includes:

a first part for indicating whether interference is received from the expected secondary-high-interference device under measurement; and

a second part for indicating whether interference is received from a device under measurement other than the expected high-interference device under measurement and the expected secondary-high-interference device under measurement.

(37) The electronic device according to (24), where received interference measurement configuration information includes:

D2D measurement configuration information for indicating time and frequency resources of the reference signal of the D2D transmitter in the devices under measurement; and

overall measurement configuration information for indicating a union of time and frequency resources of reference signals of all cellular user equipment in the devices under measurement.

(38) The electronic device according to (37), where the processing circuitry is further configured to:

measure, according to the received D2D measurement configuration information, a reception signal at a subject D2D receiver of the reference signal of the D2D transmitter in the devices under measurement, as interference of the D2D transmitter in the devices under measurement to the subject D2D receiver; and

measure, according to the received overall measurement configuration information, reception signals at the subject D2D receiver of the reference signals of all cellular user equipment in the devices under measurement, as overall interference of all cellular user equipment in the devices under measurement to the subject D2D receiver.

(39) The electronic device according to (37), where:

the reference signal of the D2D transmitter in the devices under measurement includes a channel state information reference signal or a demodulation reference signal; and

the reference signal of the cellular user equipment in the devices under measurement includes a sounding reference signal.

(40) The electronic device according to (21), where the processing circuitry is further configured to:

measure a reception power of the reception signal at the D2D receiver of the reference signal of the device under measurement according to the received measurement configuration information, as an indicator of the interference of the device under measurement to the D2D receiver.

(41) The electronic device according to (40), where the processing circuitry is further configured to:

determine, in a case that the measured reception power of the reception signal of the reference signal is greater than a power threshold, that the D2D receiver receives interference from the device under measurement.

(42) The electronic device according to (41), where the processing circuitry is further configured to: configure the power threshold based on reception power at the D2D receiver of a D2D signal and noise power at the D2D receiver.

(43) A method for wireless communication, including:

transmitting interference measurement configuration information to a D2D receiver, where the interference measurement configuration information indicates a configuration of a reference signal to be transmitted by a device under measurement, with which a D2D receiver multiplexes wireless communication resources, in a cell where the D2D receiver is located; and

receiving an interference measurement report from the D2D receiver, the interference measurement report being obtained by measuring, as interference to the D2D receiver, a reception signal at the D2D receiver of the reference signal transmitted by the device under measurement according to the interference measurement configuration information.

(44) A method for wireless communication, including:

receiving, from a base station, interference measurement configuration information indicating a configuration of a reference signal to be transmitted by a device under measurement, with which a D2D receiver multiplexes wireless communication resources, in a cell where the D2D receiver is located;

measuring, according to the received interference measurement configuration information, a reception signal at the D2D receiver of the reference signal transmitted by the device under measurement as interference to the D2D receiver to obtain an interference measurement report; and

transmitting the interference measurement report to the base station.

(45) A non-transient computer-readable storage medium storing a program, where the program, when executed by a processor, causes the processor to perform the method according to (43) or (44).

Although the embodiments of the present disclosure are described above in detail with reference to the drawings, it should be understood that the above-described embodiments are merely used for illustrating the present disclosure rather than intended to limit the present disclosure. Those skilled in the art can make various modifications and variations to the above-described embodiments without departing from the substance and scope of the present disclosure. Therefore, the scope of the present disclosure is defined only by the appended claims and their equivalents.

1. An electronic device, comprising:
processing circuitry configured to:
generate interference measurement configuration information indicating a configuration of a reference signal to be transmitted by a device under measurement, with which a D2D receiver multiplexes wireless communication resources, in a cell where the D2D receiver is located; and
transmit the interference measurement configuration information to the D2D receiver;
receive an interference measurement report from the D2D receiver, the interference measurement report being obtained by measuring, as interference to the D2D receiver, a reception signal at the D2D receiver of the reference signal transmitted by the device under measurement according to the interference measurement configuration information.

2. The electronic device according to claim 1, wherein the wireless communication resources multiplexed by the D2D receiver with the device under measurement include uplink communication resources, and
wherein the device under measurement includes uplink cellular user equipment.

3. (canceled)

4. The electronic device according to claim 2, wherein the device under measurement further includes a D2D transmitter other than a D2D transmitter corresponding to a subject D2D receiver.

5. The electronic device according to claim 1, wherein the D2D receiver and the device under measurement respectively use specific beams for communication.

6. The electronic device according to claim 1, wherein the processing circuitry is further configured to: pre-configure the reference signal for each device under measurement in the cell.

7. The electronic device according to claim 1, wherein the processing circuitry is further configured to: pre-configure the reference signals of at least some devices under measurement in the cell to occupy continuous or concentrated time and frequency resources.

8. (canceled)

9. The electronic device according to claim 7, wherein the interference measurement configuration information includes:
specific measurement configuration information, for indicating time and frequency resources of the reference signal of an expected high-interference device under measurement; and
overall measurement configuration information, for indicating a union of time and frequency resources of the reference signals of all devices under measurement.

10. (canceled)

11. The electronic device according to claim 9, wherein the received interference measurement report comprises at least:
a first part for indicating whether the D2D receiver receives interference from the expected high-interference device under measurement; and
a second part for indicating whether the D2D receiver receives interference from device under measurement other than the expected high-interference device under measurement.

12.-13. (canceled)

14. The electronic device according to claim 9, wherein the processing circuitry is further configured to: determine the expected high-interference device under measurement based on position information of the D2D receiver and position information of the device under measurement in the cell.

15.-16. (canceled)

17. The electronic device according to claim 4, wherein the interference measurement configuration information comprises:
D2D measurement configuration information for indicating time and frequency resources of the reference signal of the D2D transmitter in the devices under measurement; and
overall measurement configuration information for indicating a union of time and frequency resources of reference signals of all cellular user equipment in the devices under measurement.

18. The electronic device according to claim 17, wherein the interference measurement configuration information further comprises: specific measurement configuration information for indicating time and frequency resources of the reference signal of expected high-interference cellular user equipment.

19.-20. (canceled)

21. An electronic device, comprising:
processing circuitry configured to:
receive, from a base station, interference measurement configuration information indicating a configuration of a reference signal to be transmitted by a device under measurement, with which a D2D receiver multiplexes wireless communication resources, in a cell where the D2D receiver is located;
measure, according to the received interference measurement configuration information, a reception signal at the D2D receiver of the reference signal transmitted by the device under measurement as interference to the D2D receiver to obtain an interference measurement report; and
transmit the interference measurement report to the base station.

22. The electronic device according to claim 21, wherein the D2D receiver and the device under measurement multiplex uplink communication resources, and
wherein the device under measurement comprises uplink cellular user equipment.

23. (canceled)

24. The electronic device according to claim 22, wherein the device under measurement further comprises a D2D transmitter other than a D2D transmitter corresponding to a subject D2D receiver.

25. The electronic device according to claim 21, wherein the D2D receiver and the device under measurement respectively use specific beams for communication.

26. (canceled)

27. The electronic device according to claim 21, wherein the received interference measurement configuration information comprises:
specific measurement configuration information, for indicating time and frequency resources of the reference signal of an expected high-interference device under measurement; and
overall measurement configuration information, for indicating a union of time and frequency resources of the reference signals of all devices under measurement.

28. (canceled)

29. The electronic device according to claim 27, wherein the processing circuitry is further configured to:
measure, a reception signal at the D2D receiver of the reference signal of the high-interference device under measurement according to the received specific measurement configuration information, as interference of the high-interference device under measurement to the D2D receiver; and
measure, reception signals at the D2D receiver of the reference signals of all devices under measurement according to the received overall measurement configuration information, as overall interference of all devices under measurement to the D2D receiver.

30.-31. (canceled)

32. The electronic device according to claim 29, wherein the interference measurement report comprises at least:
a first part for indicating whether the D2D receiver receives interference from the expected high-interference device under measurement; and
a second part for indicating whether the D2D receiver receives interference from device under measurement other than the expected high-interference device under measurement.

33.-36. (canceled)

37. The electronic device according to claim 24, wherein received interference measurement configuration information comprises:
D2D measurement configuration information for indicating time and frequency resources of the reference signal of the D2D transmitter in the devices under measurement; and
overall measurement configuration information for indicating a union of time and frequency resources of reference signals of all cellular user equipment in the devices under measurement.

38.-42. (canceled)

43. A method for wireless communication, comprising:
transmitting interference measurement configuration information to a D2D receiver, wherein the interference measurement configuration information indicates a configuration of a reference signal to be transmitted by a device under measurement, with which a D2D receiver multiplexes wireless communication resources, in a cell where the D2D receiver is located; and
receiving an interference measurement report from the D2D receiver, the interference measurement report being obtained by measuring, as interference to the D2D receiver, a reception signal at the D2D receiver of the reference signal transmitted by the device under measurement according to the interference measurement configuration information.

44.-45. (canceled)
